(19) United States
(12) Patent Application Publication
(10) Pub. No.: US 2002/0118837 A1
(43) Pub. Date: Aug. 29, 2002

(54) Method and system for digital image authentication center

(76) Inventor: Jon W. Hamilton, Johnson City, TX (US)

Correspondence Address: Matthew B. Talpis, Esq., Baker Botts L.L.P., Suite 600, 2001 Ross Avenue, Dallas, TX, 75201-2980, US

(21) Appl. No.: 10/028,341

(22) Filed: Dec. 21, 2001

Related U.S. Application Data
(60) Provisional application No. 60/257,918, filed on Dec. 21, 2000.

(51) Int. Cl. H04L 9/00

(52) U.S. Cl. 380/277; 713/176

(57) ABSTRACT

A digital image (27) is taken by a digital camera (12) and a serial number (22) is associated with the digital image. The digital image is encrypted by the camera using a camera key (20) to form an encrypted image (28). The encrypted image is then communicated to an authentication center (14). The authentication center associates the encrypted image with the serial number identifying the camera and an encrypted camera key (50). At a later time, a digital image is sent by a verifying entity (16) to the authorization center to determine if the digital image has been altered. The authorization center then decrypts the encrypted image, compares the digital image to the decrypted encrypted image and reports the result to the verifying entity. Also, the digital image is encrypted. The digital image is partitioned into at least one partition. A P box is applied to each partition. A first and second S box are applied to each partition. The encrypted image is generated based the P box, the first S box and the second S box. The authentication center decrypts the digital image. The encrypted digital image is decrypted by determining at least one partition based on the encrypted digital image. At least one trajectory associated with the encrypted image is reconstructed. A reverse S2 box, a reverse S1 box and a reverse P box are applied to the partitions. The original digital image is generated based on the first reverse S box, the second reverse S box and the reverse P box.

### RELATED APPLICATIONS

This application claims the benefit under 35 U.S.C. §119(e) of U.S. Provisional Application Serial No. 60/257,918, filed Dec. 21, 2000. This application is related to co-pending U.S. application Ser. No. ______ entitled “METHOD AND SYSTEM FOR DIGITAL IMAGE AUTHENTICATION” filed ______ (attorney docket 021971.0164) and to co-pending U.S. application Ser. No. ______ entitled “METHOD AND SYSTEM FOR TRUSTED DIGITAL CAMERA” filed ______ (attorney docket 021971.0163).

### TECHNICAL FIELD OF THE INVENTION

This invention relates in general to data processing and, more specifically, to a method and system for a digital image authentication center.

### BACKGROUND OF THE INVENTION

Photographs are often used to provide a visual representation of some portion of the real world. For example, an insurance investigator may take a photograph in order to preserve the look of a vehicle after an accident. As computers have become increasingly important in today's society, the use of digital cameras has also increased. Digital cameras may provide decreased support costs by removing the need for film and developing. Another of the benefits of digital cameras is that the entirely digital images produced by the digital cameras are easily modified. However, this benefit may become a liability in situations where the authenticity of the image is important. Referring back to the insurance investigator example above, the investigator may be prevented from utilizing the advantages provided by a digital camera because of questions regarding the authenticity of images taken by the digital camera. Typically, existing digital cameras have provided minimal mechanisms for preserving digital images in their original form.

### SUMMARY OF THE INVENTION

The present invention provides an improved method and system for a digital image authentication center. In one embodiment of the present invention, a method and system for authenticating a digital image is provided. A first digital image is received at an authentication center. The first digital image has an associated serial number and is encrypted. The first digital image is stored at the authentication center in response to the associated serial number. A second digital image is received at the authentication center. The second digital image being associated with the serial number. The first digital image is decrypted to generate a third digital image. The second digital image is compared to the third digital image and the result of the comparison are reported.

The present invention provides important technical advantages. Various embodiments of the invention may have none, some, or all of these advantages. The invention provides the ability to store encrypted images from a digital camera for later authentication of images. More specifically, digital images may be presented to the authentication center to determine whether the images have been altered from the images originally taken by the digital camera.

### BRIEF DESCRIPTION OF THE DRAWINGS

A better understanding of the present invention will be realized from the detailed description that follows, taken in conjunction with the accompanying drawings, in which:

FIG. 1 is a block diagram illustrating an image authentication system;

FIG. 2 is a flowchart illustrating a method for creating a trusted digital camera of the system of FIG. 1;

FIG. 2A is a block diagram illustrating further details of an authorization center of the system of FIG. 1;

FIG. 3 is a flowchart illustrating a method for generating a verifiable image with the trusted digital camera of FIG. 1;

FIG. 4 is a flowchart illustrating a method for verifying a digital image using the system of FIG. 1; and

FIG. 5 is a block diagram of an exemplary system for verifying a digital image using the system of FIG. 1;

FIG. 6 is a block diagram illustrating an exemplary use of the system of FIG. 1;

FIG. 7 is a block diagram illustrating an overview of a MAKO algorithm used in the system of FIG. 1;

FIG. 8 is a block diagram illustrating further details of the MAKO algorithm as used in the system of FIG. 1;

FIG. 9 is a flow diagram illustrating an overview of the encryption portion of the MAKO algorithm according to one embodiment of the present invention;

FIG. 10 is a flow diagram illustrating further details of the encryption portion of the MAKO algorithm according to one embodiment of the present invention;

FIG. 11 is a flow diagram illustrating details of a partitioning portion of the MAKO algorithm according to one embodiment of the present invention;

FIG. 12 is a flow diagram illustrating a cryptographic key exchange protocol for use with the MAKO algorithm according to one embodiment of the present invention;

FIG. 13 is a block diagram illustrating details of a rotation matrix used in association with the cryptographic key exchange protocol of FIG. 12 according to one embodiment of the present invention;

FIG. 14 is a flow diagram illustrating the operation of a P box portion of the MAKO algorithm according to one embodiment of the present invention;

FIG. 15 is a flow diagram illustrating the operation of an S₁ box used with the MAKO algorithm according to one embodiment of the present invention;

FIG. 16 is a flow diagram illustrating the operation of an S₂ box of the MAKO algorithm according to one embodiment of the present invention;

FIG. 17 is a flow diagram illustrating the generation of trajectories for use with the MAKO algorithm according to one embodiment of the present invention;

FIG. 18 is a flow diagram illustrating an overview of the decryption portion of the MA KO algorithm according to one embodiment of the present invention;

FIG. 19 is a flow diagram illustrating the reconstruction of a trajectory for use with the decryption portion of the MAKO algorithm according to one embodiment of the present invention;

FIG. 20 is a flow diagram illustrating more details of the encryption portion of the MAKO algorithm according to one embodiment of the present invention;

FIG. 21 is a block diagram illustrating details of a digital image enumeration scheme for use with the MAKO algorithm according to one embodiment of the present invention;

FIG. 22 is a block diagram illustrating further details of the partitioning portion of the MAKO algorithm according to one embodiment of the present invention;

FIG. 23 is a flow diagram illustrating further details of cryptographic key exchange protocols used with MAKO according to one embodiment of the present invention;

FIG. 24 is a flow diagram illustrating further details of the P box as used with the MAKO algorithm according to one embodiment of the present invention;

FIG. 25 is a table illustrating a rotation matrix R₃ used with the MAKO algorithm according to one embodiment of the present invention;

FIG. 26 is a flow diagram illustrating further details of the S₁ box used with the MAKO algorithm according to one embodiment of the present invention;

FIG. 27 is a block diagram illustrating a bit enumeration of nibbles used with the MAKO algorithm according to one embodiment of the present invention;

FIG. 28 is a flow diagram illustrating a nibble test procedure used with the MAKO algorithm according to one embodiment of the present invention;

FIG. 29 is a block diagram illustrating nonlinear feedback shift register number 3 used with the MAKO algorithm according to one embodiment of the present invention;

FIG. 30 is a flow diagram illustrating further details of the S₂ box used with the MAKO algorithm according to one embodiment of the present invention;

FIG. 31 is a flow diagram illustrating the generation of trajectories used with the MAKO algorithm according to one embodiment of the present invention;

FIG. 32 is a table illustrating the MAKO TABLE used with the S₁ box of the MAKO algorithm according to one embodiment of the present invention.

FIG. 33 is a table illustrating the R₁ rotation matrix used with the MAKO algorithm according to one embodiment for the present invention;

FIG. 34 is a table illustrating the R₂ rotation matrix used with the MAKO algorithm according to one embodiment of the present invention;

FIG. 35 is a block diagram illustrating nonlinear feedback shift register number one used with the MAKO algorithm according to one embodiment of the present invention;

FIG. 36 is a block diagram illustrating nonlinear feedback shift register number two used with the MAKO algorithm according to one embodiment of the present invention; and

FIG. 37 is a table illustrating the R₄ rotation matrix used with the MAKO algorithm according to one embodiment of the present invention.

### DETAILED DESCRIPTION OF THE INVENTION

The preferred embodiment of the present invention and its advantages are best understood by referring to FIGS. 1-37 of the drawings, like numerals being used for like and corresponding parts of the various drawings.

FIG. 1 is a block diagram illustrating a trusted digital camera system 10. System 10 comprises a trusted digital camera 12, an authentication center 14, a verifying entity 16 and a camera activator 18.

Trusted digital camera 12 comprises a camera key 20, a camera serial number 22, a communications interface 23, a processor 24, computer readable storage 26, an image 27, an encrypted image 28 and embedded annotations 29. Key 20 may comprise a 128-bit value uniquely associated with camera 12. Key 20 may alternatively comprise any unique value of suitable length for providing a desired level of security to images taken by camera 12. Key 20 is used to encrypt images 27 to generate encrypted images 28.

Serial number 22 comprises a unique 32-bit numeric value associated with camera 12. Serial number 22 may be used for identifying camera 12 and providing increased strength to the encryption of images generated at camera 12. In one embodiment, serial number 22 may comprise a unique identifier associated with a smart card or some other externally provided unique value. In this embodiment, camera 12 may not operate until serial number 22 is provided to camera 12.

Communications interface 23 comprises any wireless or wireline communication system operable to communicate data from camera 12 to authorization center 14. For example, communications interface 23 may comprise a digital wireless interface, such as a Cellular Digital Packet Data (CDPD) interface. For another example, interface 23 may comprise a Universal Serial Bus (USB) interface for communicating with a computer.

Processor 24 comprises any suitable general purpose or special purpose computer processing unit, such as a central processing unit, operable to execute software stored in storage 26. Storage 26 may comprise read only memory (ROM), random access memory (RAM), magnetic storage devices, optical storage devices, dynamic random access memory (DRAM) and any other type of persistent or transient storage devices or technology in any combination for storing data and programs for use with processor 24. Storage 26 may be formed integral to camera 12 or may be removable therefrom. Also, portions of storage 26 may be formed integral to camera 12 while other portions are removable therefrom.

Storage 26 stores image 27, encrypted image 28 and annotations 29. Image 27 comprises a digital representation of a visual image received by camera 12, such as through a lens (not shown). Encrypted image 28 comprises an encrypted version of image 27 such that image 27 may not be reconstructed from encrypted image 28 without the proper decryption algorithm and key 20. Typically, camera 12 is incapable of decrypting image 28.

Embedded annotations 29 may comprise any text and other annotations the user of camera 12 wishes to add to image 27. Embedded annotations 29 may be added to any location on image 27 and may also be added around or outside of image 27. Annotations 29 may also be embedded with image 27 invisibly to the user of camera 12. For example, serial number 22 may be invisibly embedded as an annotation 29 in image 27 for later use by authorization center 14. Annotations 29 may also include the time that image 27 was taken by camera 12, and the imaging conditions such as exposure, focal length, type of film, shutter speed and other camera related information. In general, any text or other information may be added as annotations 29 to image 27. Annotations 29 may be encrypted as part of encrypted image 28.

More specifically, one of the annotations 29 may comprise a picture counter 35. Picture counter 35 may comprise a sequentially increasing numeric value for identifying individual images 27 from a particular camera 12. Counter 35 may also comprise any identifier for identifying individual images 27 from camera 12.

Verifying entity 16 comprises a human, organization or other entity who wishes to authenticate an image taken by a camera 12, such as image 27. Verifying entity 16 further comprises an entity identifier 33 for uniquely identifying the verifying entity to authorization center 14.

In operation, an image is received at camera 12 and stored digitally as image 27. Image 27 may be stored using any imaging coding format associated with camera 12. For example, the graphics interchange file (GIF) format, the joint photographers expert group (JPEG) file format, the bitmap format and other formats may be used. Camera 12 next adds picture counter 35 to annotations 29 and increments picture counter 35 for use with the next image 27. Picture counter 35 may be used to distinguish images 27 from camera 12. A user (not shown) of camera 12 may then add other embedded annotations 29 to image 27. Camera 12 then encrypts image 27 and any embedded annotations 29 to generate encrypted image 28. Camera 12 may encrypt image 27 to generate encrypted image 28 using the MAKO algorithm described in association with FIGS. 7-37, but any encryption technique may be used.

Encrypted image 28 is then communicated to authorization center 14. Image 28 may be communicated to authorization center 14 using any wireless or wireline communication system. For example, image 28 may be communicated wirelessly from a cellular based communications interface 23 of camera 12. For another example, image 28 may be communicated from camera 12 to a computer (not shown) coupled to the Internet using interface 23 and then communicated from the computer to authorization center 14. Encrypted image 28 may be communicated immediately after encrypted image 28 is generated or at some later time. Authorization center 14 then stores encrypted image 28.

Verifying entity 16 communicates image 27 to be verified to authentication center 14 where authentication center 14 decrypts the appropriate encrypted image 28 to recover the image 27 which the encrypted image 28 was generated from using serial number 22 and key 20. More specifically, serial number 22 associated with image 27 may be used to determine which encrypted image 28 to decrypt. Once serial number 22 has identified the particular camera 12 which generated image 27, picture counter 35 may then be used to determine the particular image 27 from camera 12 to be verified. Image 27 is then compared to the image provided by verifying entity 16 then the results of the comparison is communicated to verifying entity 16 and/or any other entity, such as a court, whom verifying entity 16 has indicated the results should be communicated to. Authorization center 14 may also communicate image 27 to verifying entity 16 or other interested entities.

Camera activator 18 may comprise a physical manufacturer of cameras 12, a reseller of cameras 12 or any other business entity operable to load key 20 and serial number 22 into camera 12. More specifically, camera activator 18 indicates the entity which loads key 20 and serial number 22 into camera 12. For example, key 20 and serial number 22 may be loaded into camera 12 at the time of the purchase of the camera at a retail outlet. In this example, activator 18 would comprise a retailer because the retailer is the one loading key 20 and serial number 22 into camera 12. For another example, key 20 and serial number 22 may be loaded into camera 12 when camera 12 is physically manufactured. In this example, activator 18 comprises the manufacturer. Activator 18 further comprises an activator identifier 32. Activator identifier 32 comprises a unique identifier indicating the identity of the activator, such as a retailer or manufacturer of camera 12.

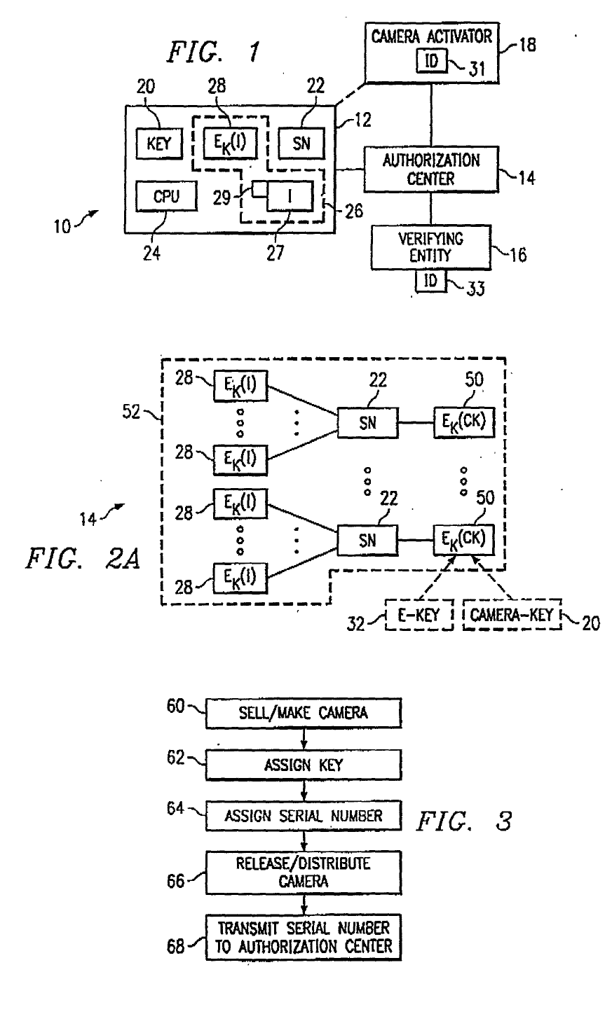

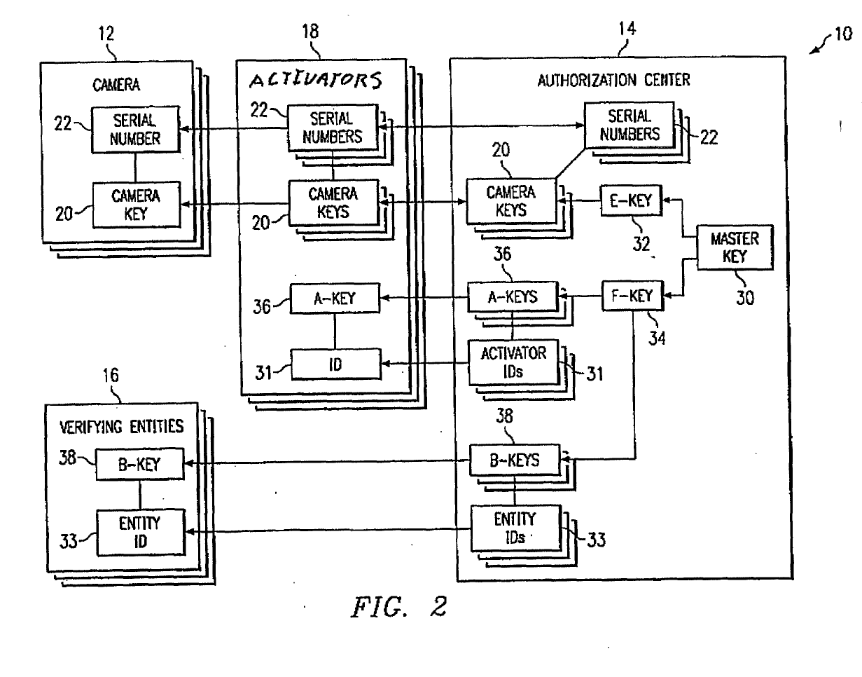

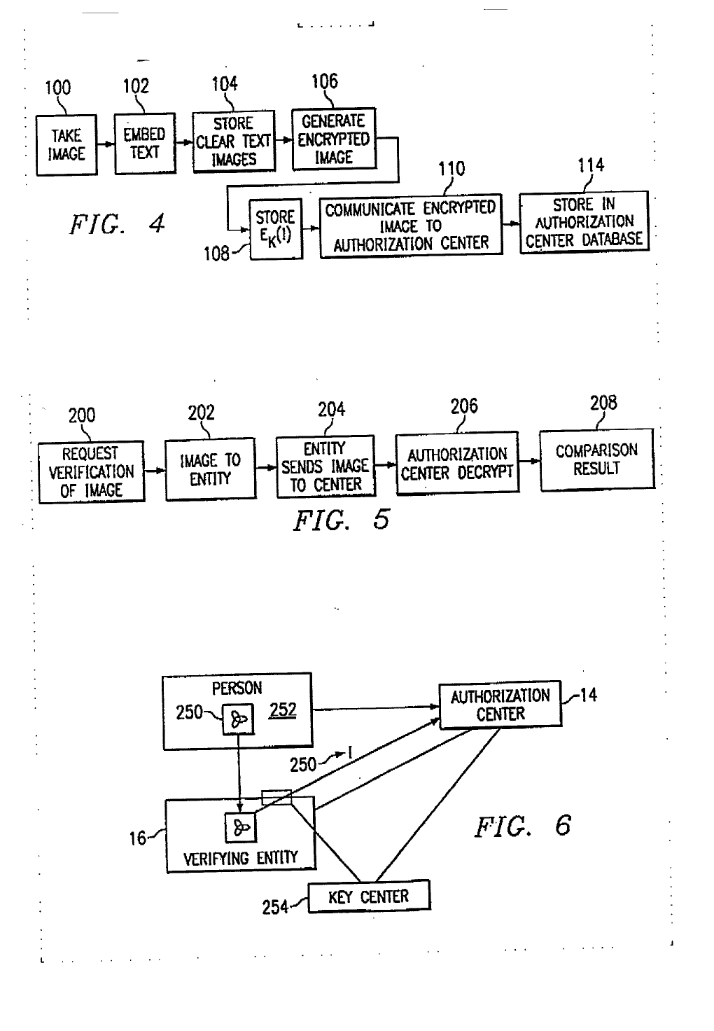

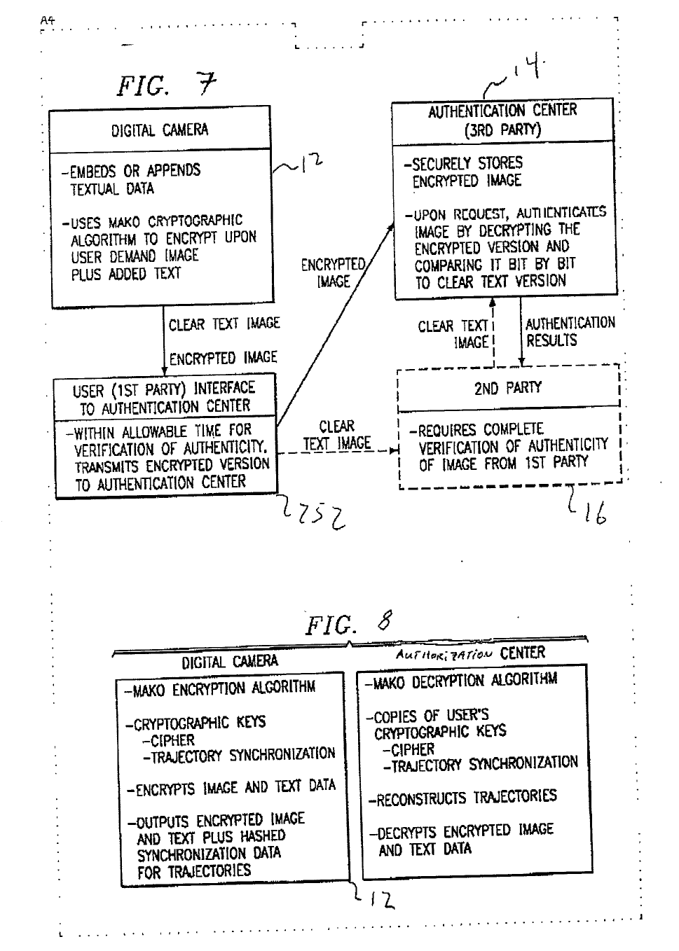

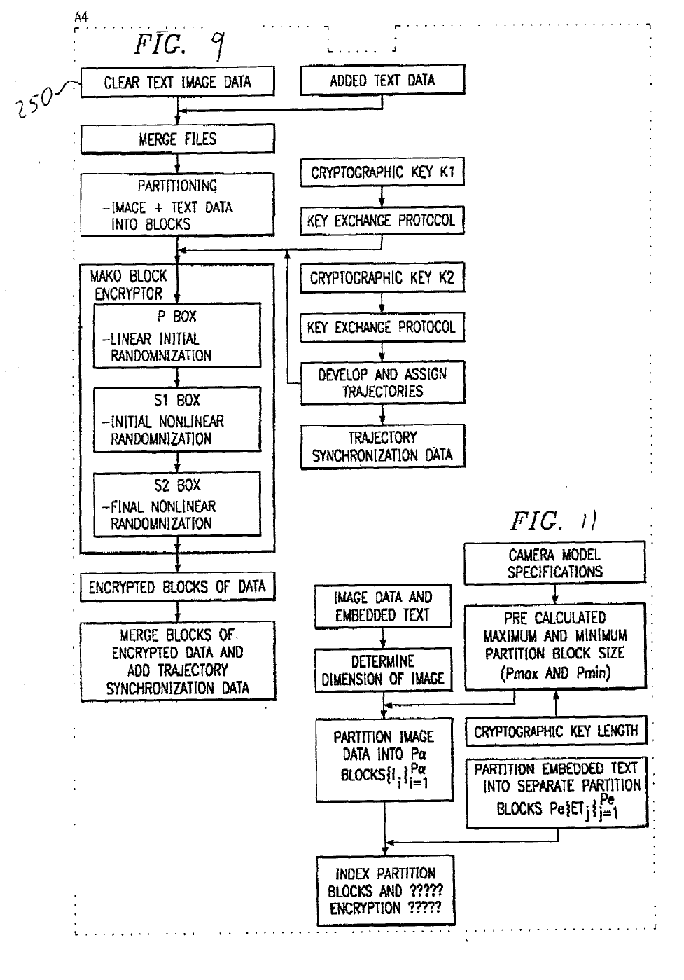

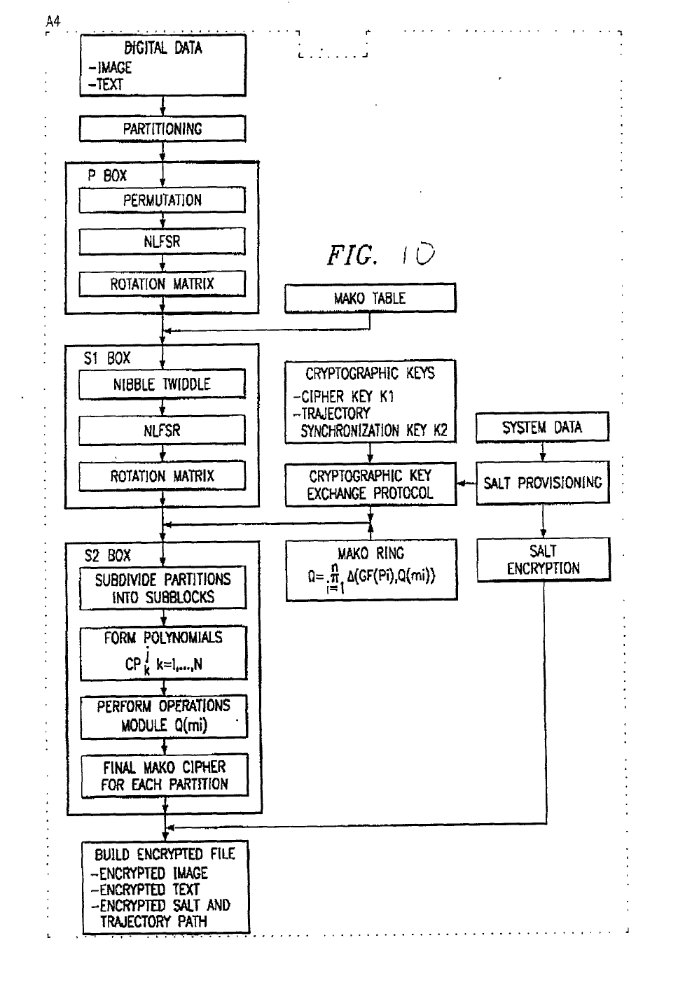

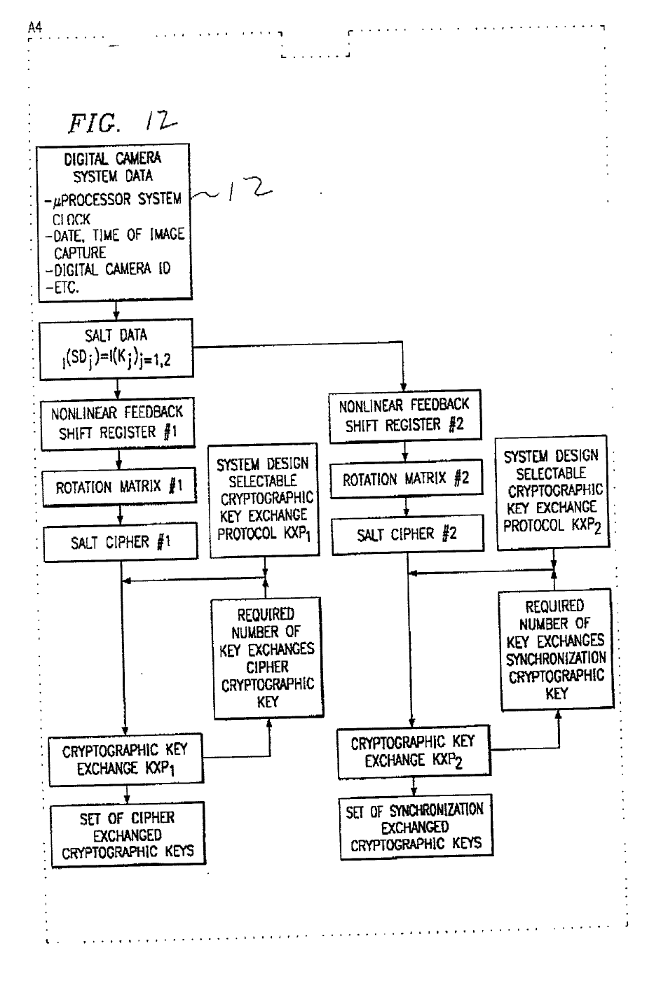

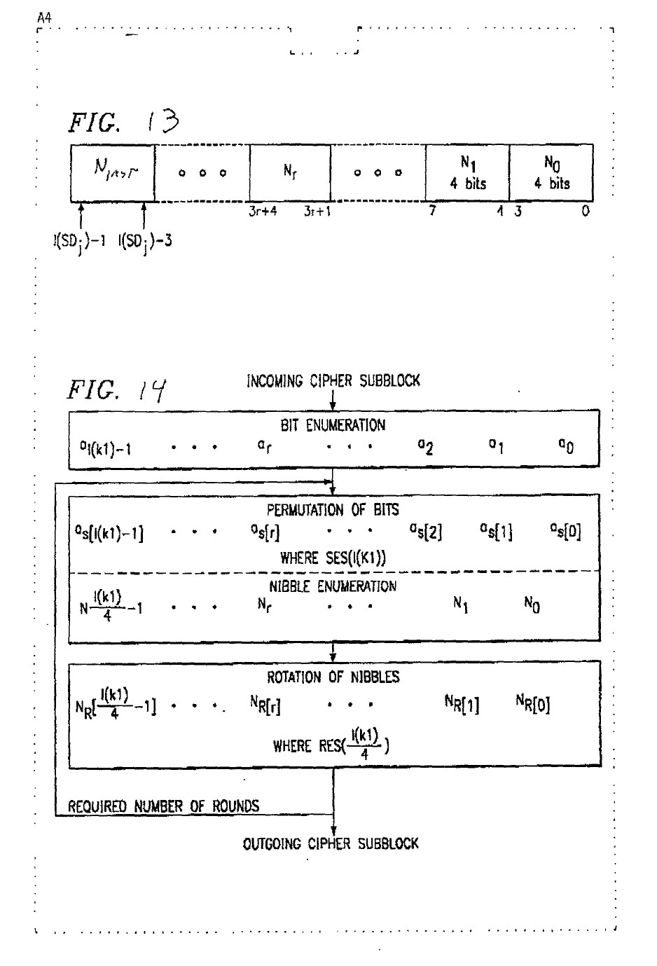

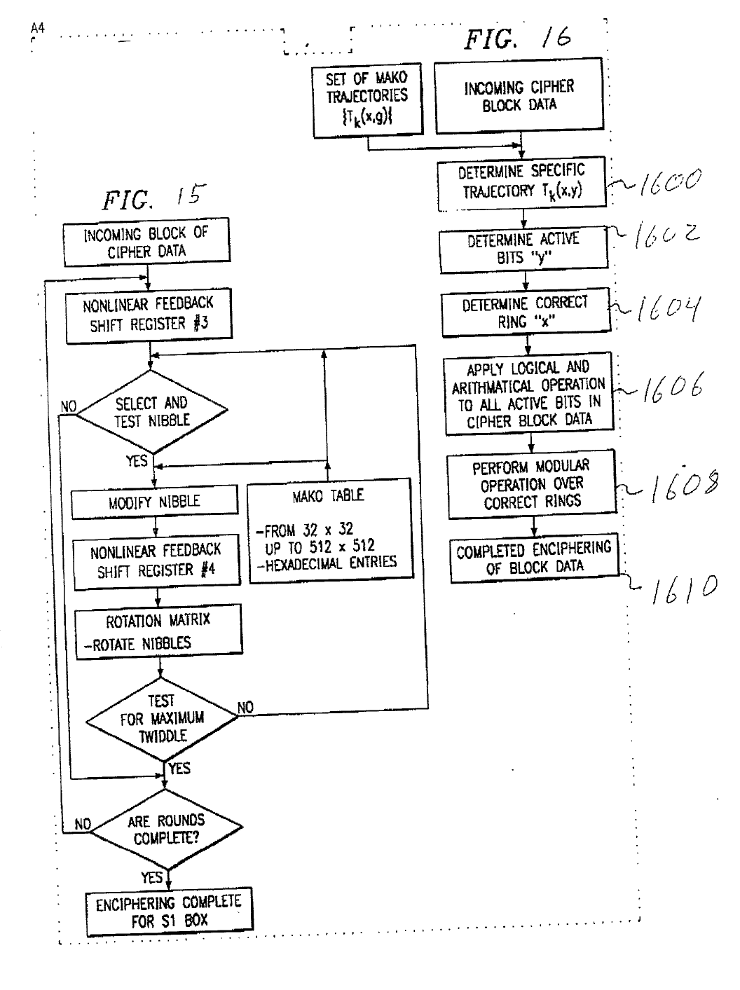

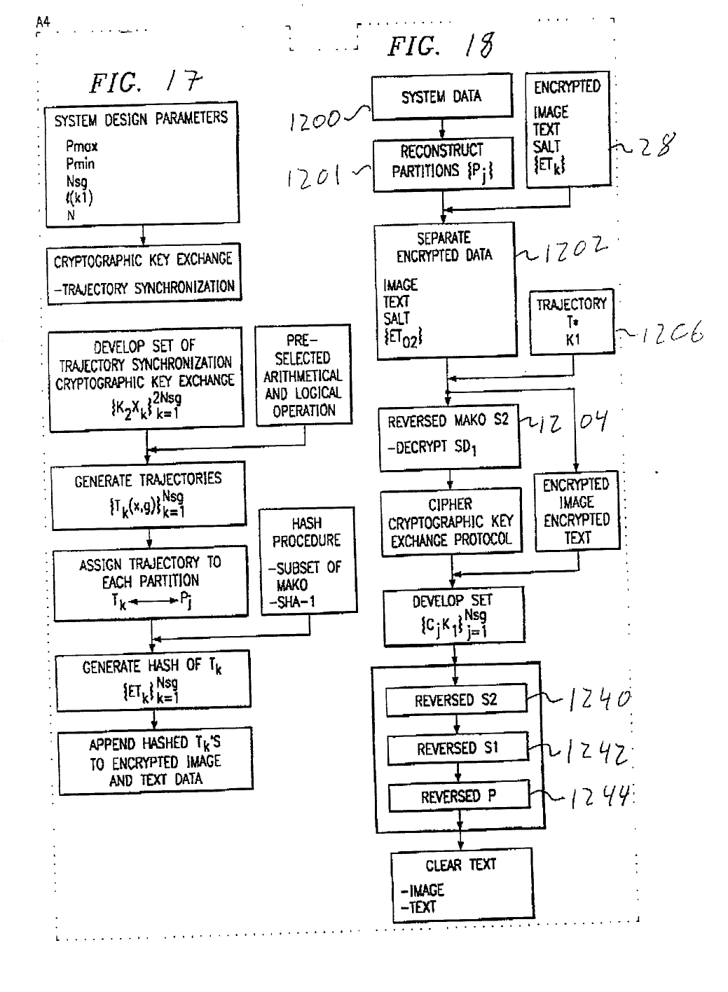

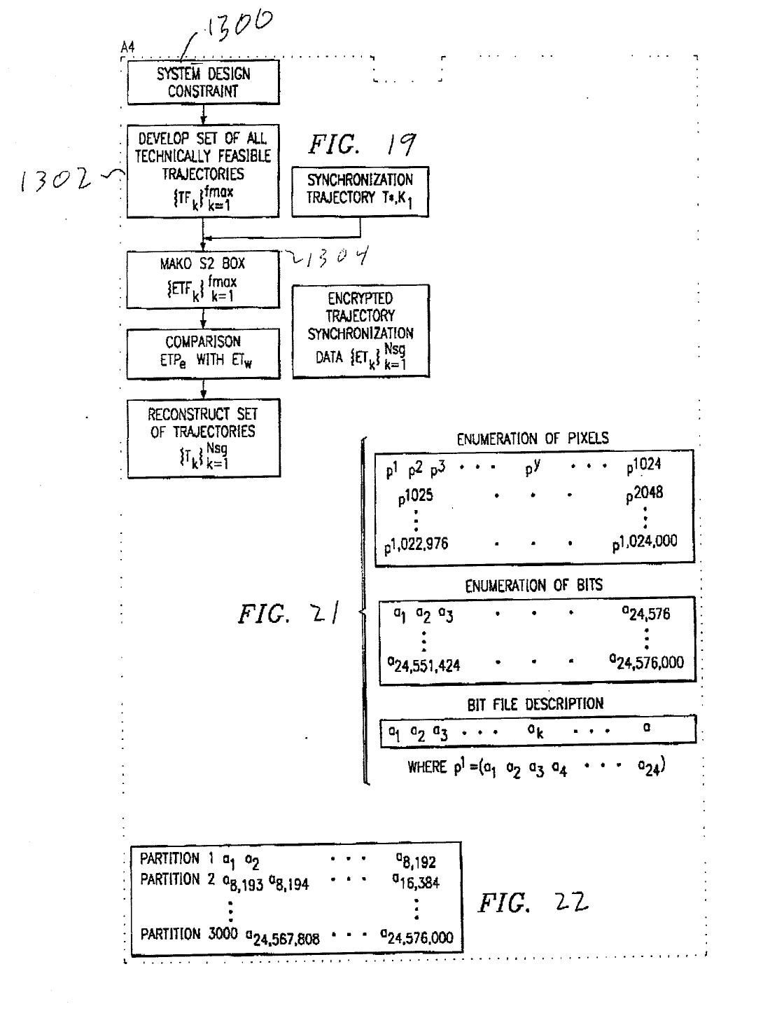

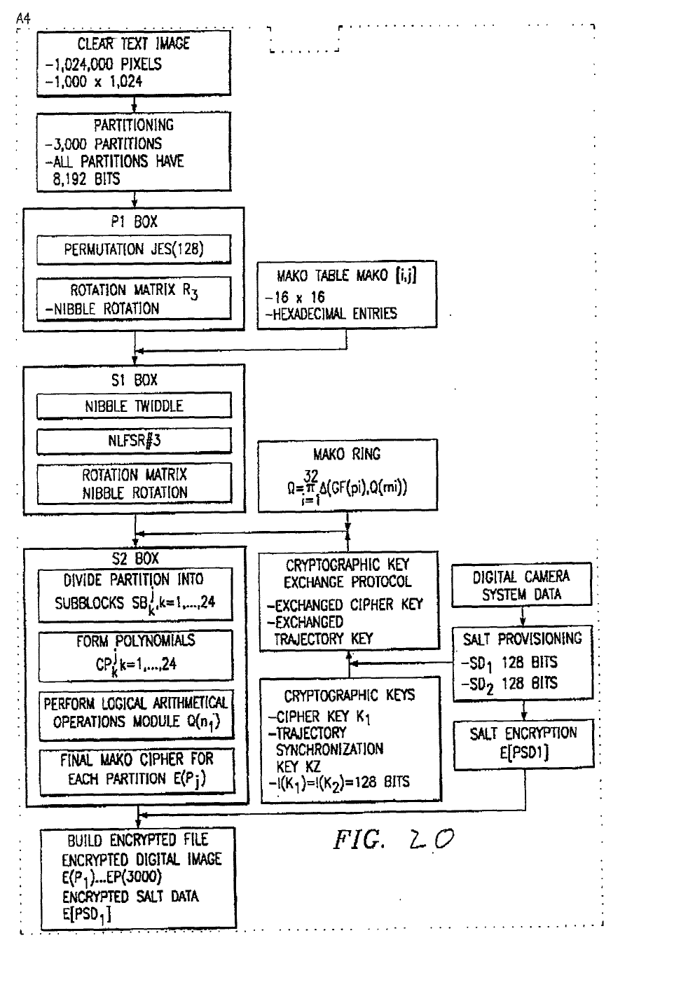

FIG. 2 is a block diagram illustrating further details of system 10. Authorization center 14 further comprises a master key 30, one or more activation IDs 31, an E-key 32, an entity ID 33, an F-key 34, one or more A-keys 36, and one or more B-keys 38.

Master key 30 comprises a 128-bit key for encrypting E-keys 32 and F-keys 34. Master key 30 may alternatively be of any length for providing a desired level of encryption security for E-keys 32 and F-keys 34. Master key 30 may be used in conjunction with a symmetric encryption algorithm, but may also be used with a non-symmetric encryption algorithm. For example, E-keys 32 and F-keys 34 may be encrypted by master key 30 using an elliptic curve algorithm. Master key 30 is used to provide increased security from internal data theft attempts, such as by employees.

As used herein, a desired level of security may be based on one or more considerations. One consideration may comprise the financial investment in computing required by an attacker to break the encryption. For example, a key length may be chosen for a particular encryption/decryption method such that $10 million worth of computer power would be needed by an attacker to break the encryption. Another consideration may comprise the importance of the information to be protected. For example, a shopping list may need minimal encryption while classified information may need very strong encryption. Yet another consideration may comprise the chance of attack by a third party. A further consideration is the amount of time required by an attacker to break the encryption. For example, a particular length of key may require 15 hours to break using a particular computer processor while another key length may require ten years to break using a particular computer processor. In general, multiple considerations may be involved in determining the length of a particular key used by a particular user within the scope of the invention. Often, longer keys correspond with increased security.

Activator IDs 31 each comprise a numeric, alphanumeric or other identifier for identifying activators 18. Typically, each identifier 31 is distinct from each other identifier 31 for uniquely identifying the activator 18 to be associated with ID 31. As used herein, each means every one of at least a subset of the available items.

E-key 32 comprises a 128-bit encryption key for encrypting camera keys 20 at authorization center 14. E-key 32 may alternatively comprise any length of key for providing a desired level of security. E-key 32 may be used with a symmetric encryption algorithm, but may also be used with a non-symmetric encryption algorithm. E-key 32 is used to encrypt camera keys 20 in order to provide increased security against theft of camera keys 20 from authorization center 14. For example, E-key 32 may be used with an elliptic curve algorithm for encrypting camera keys 20.

Entity IDs 33 each comprise a numeric, alphanumeric, or other identifier for identifying entity 16. Typically, each entity ID 33 is distinct from each other entity ID 33 for uniquely identifying entity 16 to be associated with ID 33.

F-key 34 comprises a 128-bit encryption key used to encrypt A-keys 36 and B-keys 38 for increased security. F-key 34 may also comprise any length of key for providing a desired level of security. F-key 34 may be used with a symmetric encryption algorithm, but may also be used with a non-symmetric encryption algorithm. F-key 34 is used to provide increased security against theft of A-keys 36 and B-keys 38 from authorization center 14. For example, F-key 34 may be used with an elliptic curve algorithm for encrypting A-keys 36 and B-keys 30.

A-keys 36 comprise 128-bit encryption keys for encrypting communications with activators 18. A-keys 36 may alternatively comprise any length of encryption key for a desired level of security. Typically, A-keys 36 are used with a symmetric encryption algorithm, but a non-symmetric encryption algorithm may also be used. A-keys 36 may be used as part of the verification of the identity of activators 18. For example, elliptic curve cryptography, triple-DES (Data Encryption Standard) encryption may be used.

B-keys 38 comprise 128-bit keys for encrypting communications with verifying entities 16. B-keys 38 may alternatively comprise any length of encryption key for a desired level of security. B-keys 38 may be associated with a symmetric encryption algorithm, but may also use a non-symmetric encryption algorithm. B-keys 38 may be used to identify verifying entities 16 and encrypt communications between authorization center 14 and verifying entities 16. For example, elliptic curve cryptography or triple-DES (Data Encryption Standard) encryption may be used.

In operation, authorization center 14 is provisioned with camera keys 20, serial numbers 22, A-keys 36, activator IDs 31, B-keys 38 and entity IDs 33 for use with cameras 12, verifying entities 16 and activators 18. Camera keys 20 may be generated at or for authorization center 14 such that each camera key 20 may be distinct from each other camera key 20. For example, camera keys 20 may be selected from a pseudo-random number generator operable to generate keys of a desired lengths, such as 128-bits, with weak keys being discarded. Similarly, each A-key 36 may be distinct from each other A-key 36, each activator ID 31 may be distinct from each other activator ID 31, each B-key 38 may be distinct from each other B-key 38 and each entity ID 33 may be distinct from each other entity ID 33. Camera keys 20, A-keys 36, serial numbers 22, activator IDs 31, B-keys 38, and entity IDs 33 are distributed from authorization center 14 to activators 18 and verifying entity 16.

A-keys 36 and activator IDs 31 are provided to activators 18 from authorization center 14. Each A-key 36 has an associated activator ID 31. An associated pair of A-keys 36 and activator IDs 31 are provided to activators 18 from authorization center 14 for identification of particular activators 18 and to provide secure communication with activators 18. A-key 36 and activator ID 31 are provided to activators 18 in a secure fashion, such as using public key/private key encryption. Each activator 18 receives one unique activator ID 31 and one unique A-key 36. The A-key 36 may then be used to encrypt communication between activators 18 and authorization center 14. Activator ID 31 is used to identify activator 18 in communications with authorization center 14.

For example, a particular activator ID 31 and associated A-key 36 are communicated to an activator 18 from authorization center 14 over the Internet using public/private key encryption of the A-key 36 and ID 31. Activator 18 then requests a plurality of keys 20 and serial numbers 22 for activating cameras 12. Authorization center 14 then verifies the A-key 36 and ID 31 received from activator 18 in the request. If the A-key 36 and ID 31 are correct, then authorization center 14 may encrypt the keys 20 and serial numbers 22 being sent to activator 18 using A-key 36. The encrypted keys 20 and serial numbers 22 may then be communicated over the Internet to activator 18 using public/private key encryption to encrypt the communications over the Internet. Activator 18 may then decrypt keys 20 and serial numbers 22 using A-key 36. Thus, two levels of encryption may be provided for increased security.

A plurality of camera keys 20 and serial numbers 22 are then provided to activators 18. Each camera key 20 is uniquely associated with one serial number 22 so that when activators 18 load serial numbers 22 and camera keys 20 onto cameras 12, the serial number 22 identifiers the particular camera 12 and key 20. Serial numbers 22 serve to identify camera 12 and allow retrieval of the associated camera key 20 at authorization center 14 for later decryption of images taken by camera 12.

Activators 18 load a unique serial number 22 and associated camera key 20 into each camera 12. Serial number 22 uniquely identifies camera 12 to authorization center 14 and may optionally be used to identify the activator 18 who activated camera 12. Camera key 20 is used by camera 12 to encrypt images 27 taken by camera 12.

B-keys 38 and entity IDs 33 are provided to entities 16 from authorization center 14. Each B-key 38 has an associated entity ID 33. An associated pair of B-keys 38 and entity IDs 33 are provided to entities 16 from authorization center 14 for identification of particular entities 16 and to provide secure communication with entities 16. B-key 38 and entity ID 33 may be provided to entities 16 in a secure fashion, such as using public key/private key encryption. Each entity 16 receives one unique entity ID 33 and an associated unique B-key 38. The B-key 38 may then be used to encrypt communication between entity 16 and authorization center 14. Entity ID 33 is used to identify entity 16 in communications with authorization center 14.

For example, a particular entity ID 33 and associated B-key 38 are communicated to an entity 16 from authorization center 14 over the Internet using public/private key encryption of the B-key 38 and ID 33. Entity 16 then requests authentication of an image. The image may be encrypted by entity 16 using B-key 38 and communicated to authorization center 14 along with ID 33. The encrypted image may be communicated to authorization center 14 over the Internet using public key/private key encryption. Authorization center 14 then verifies ID 33 received from entity 16. If ID 33 is correct, then authorization center 14 decrypts the image using B-key 38. Thus, two levels of encryption may be provided for increased security.

Camera keys 20, A-keys 38, and B-keys 38 stored at authorization center 14 are encrypted using E-key 32 and F-key 34. More specifically, E-key 32 is used to encrypt camera keys 20 and F-key 34 is used to encrypt A-keys 36 and B-keys 38 at authorization center 14. Keys 20, 36 and 38 are encrypted in order to provide increased security against theft of keys 20, 36 and 38 from authorization center 14. For example, a disgruntled employee at authorization center 14 may attempt to steal keys 20, 36 and 38, and E-keys 32 and F-keys 34 are used to prevent employees from getting the clear text version of keys 20, 36 and 38. For another example, an electronic intruder may obtain unauthorized access to authorization center 14 and attempt to steal keys 20, 36 and 38. However, since keys 20, 36 and 38 are encrypted, the electronic intruder is only capable of stealing the encrypted version of keys 20, 36 and 38. The intruder would then have to decrypt keys 20, 36 and 38 which may require an extensive financial investment in computing power since keys 20, 36 and 38 are not useful until they have been decrypted.

In addition, master key 30 may be used to encrypt E-key 32 and F-key 34 in order to provide further increased security. Further, for even greater security, master key 30 may be rotated on a periodic basis, such as weekly or monthly, and used to re-encrypt E-key 32 and F-key 34 at authorization center 14. By changing master key 30 on a periodic basis, not only must an intruder gain the master key 30, but must also gain the master key 30 for the particular period of time in which the intruder will attempt to steal E-key 32 and F-key 34. Thus, to steal a camera key 20, an A-key 36 or a B-key 38, an intruder may have to also steal E-key 32, F-key 34 and master key 30. Other information, such as keys, may be included and described information excluded within the scope of the invention.

FIG. 2A is a block diagram illustrating further details of authorization center 14. Authorization center 14 further stores encrypted images 28 associated with serial numbers 22 and an encrypted camera key 50 in a database 52. Encrypted images 28 from camera 12 are communicated to authorization center 14 and associated with the serial number 22 associated with the particular camera 12 which generated the encrypted images 28. An encrypted camera key 50 is also associated with each serial number 22. Encrypted camera key 50 comprises an encrypted version of camera key 20 generated by encrypting camera key 20 with E-key 32. Database 52 may comprise a hierarchical, relational, objected-oriented or any other database operable to store and retrieve data. Database 52 may also be a distributed database.

In operation, authorization center 14 generates or receives keys 20 and serial numbers 22. Keys 20 are then encrypted using E-key 32 to generate encrypted keys 50 which are stored in database 52 and respectively associated with respective serial numbers 22. Center 14 provides keys 20 and serial numbers 22 to activators 18 and may then destroy keys 20 so that only encrypted keys 50 are stored at center 14. Center 14 receives images 28 from cameras 12. Images 28 may be communicated to center 14 wirelessly, over the Internet, from a computer connected to camera 12 and by any other wireless or wireline method. Images 28 are received with the serial number 22 associated with camera 12. Center 14 then stores images 28 in database 52 for later use.

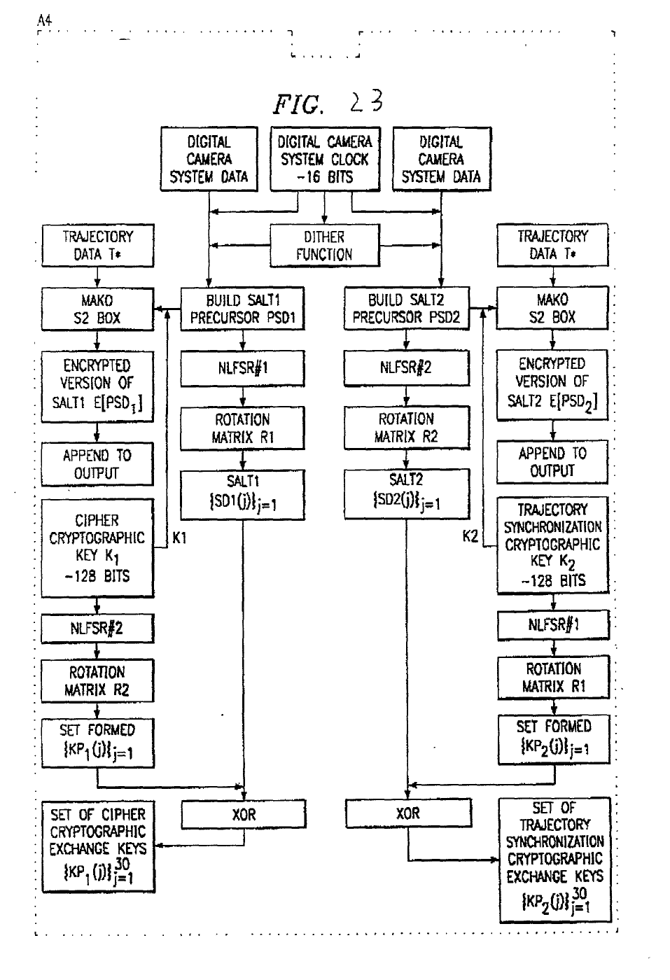

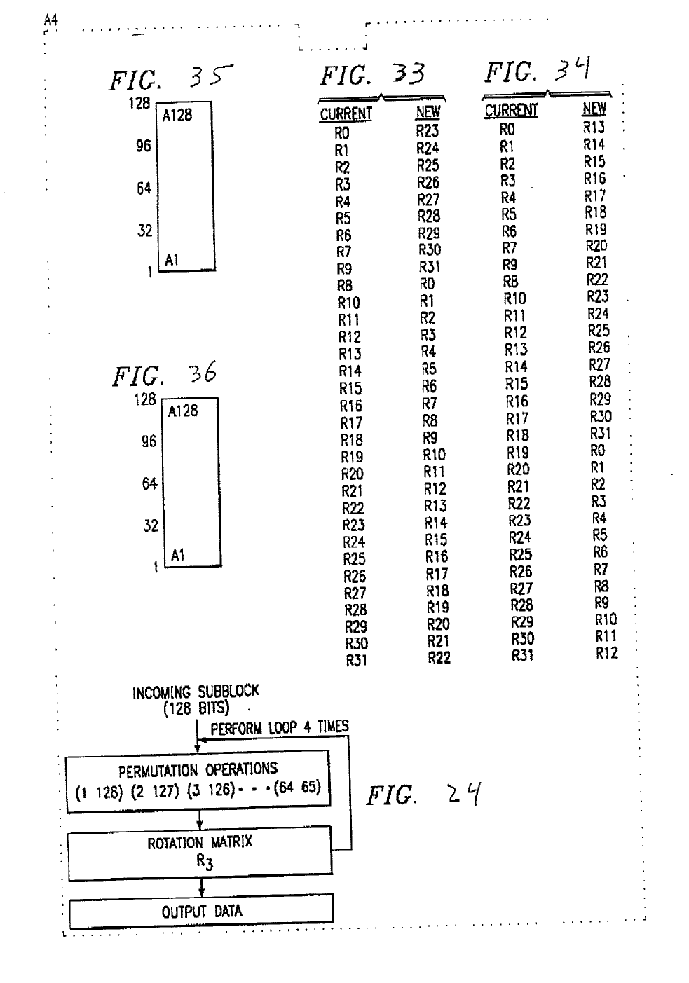

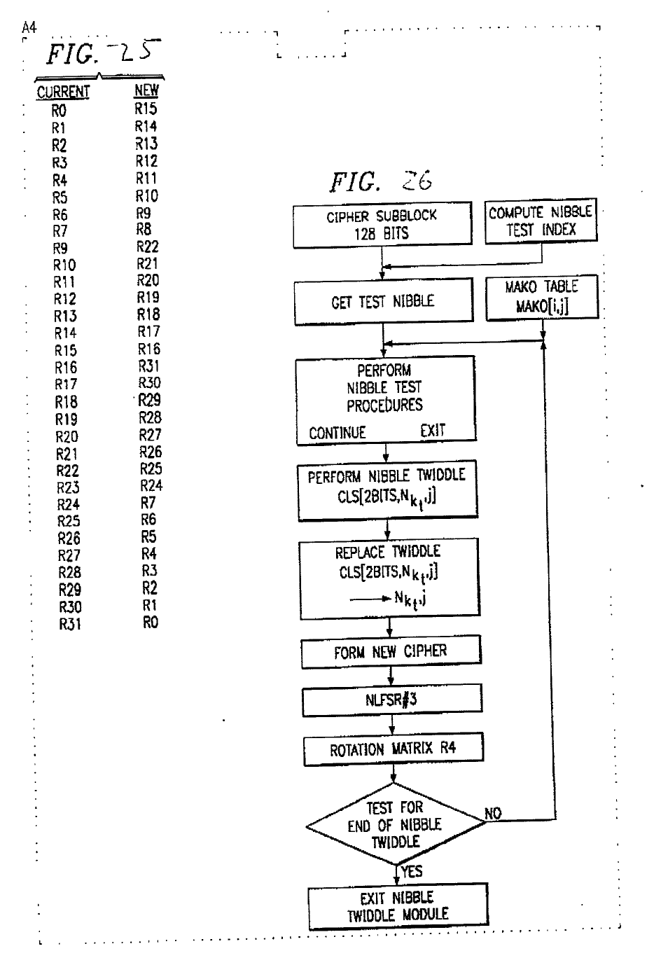

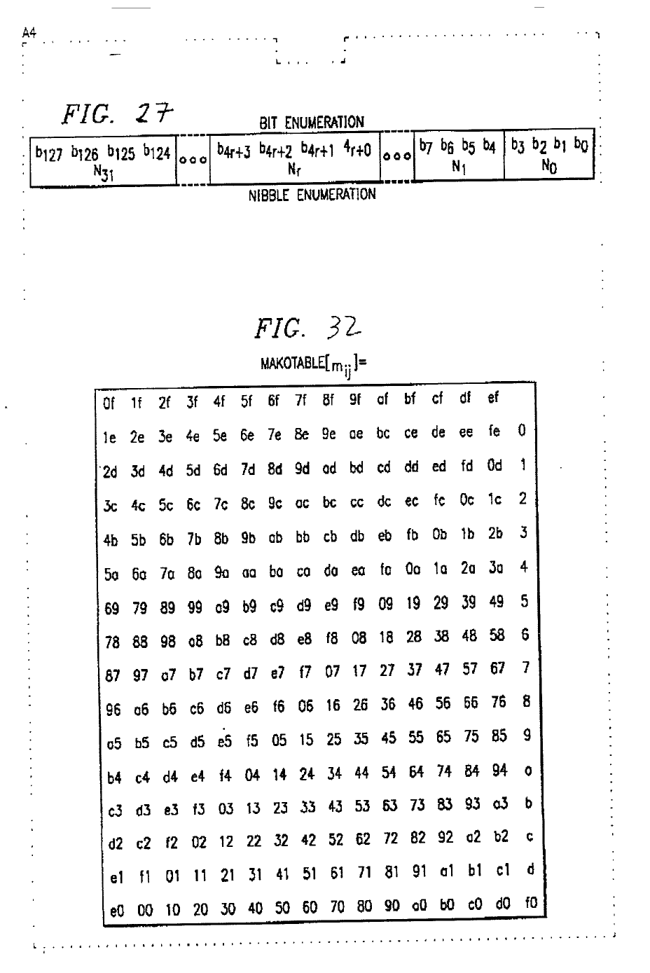

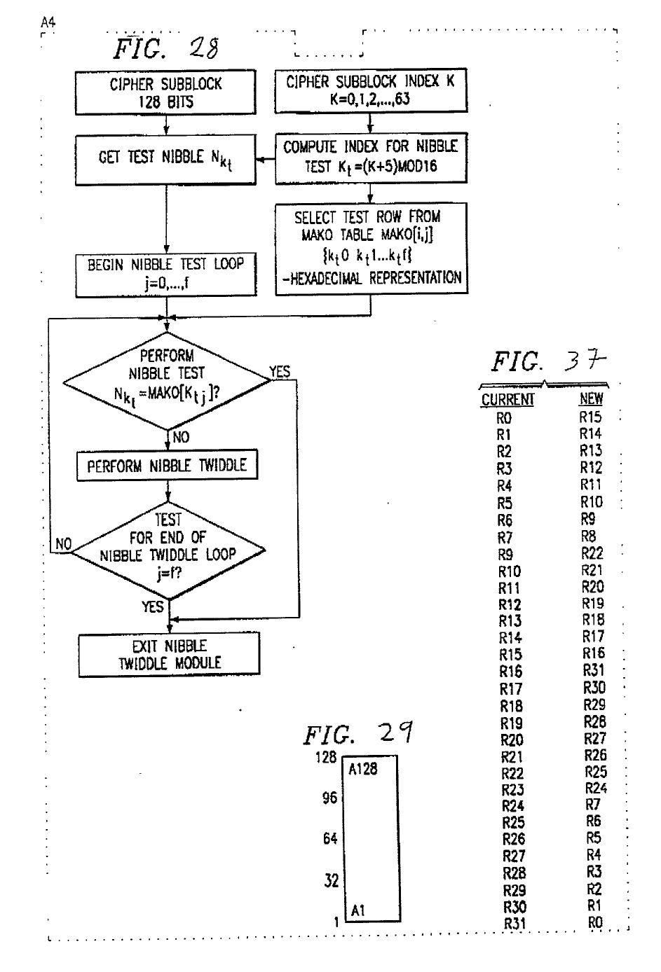

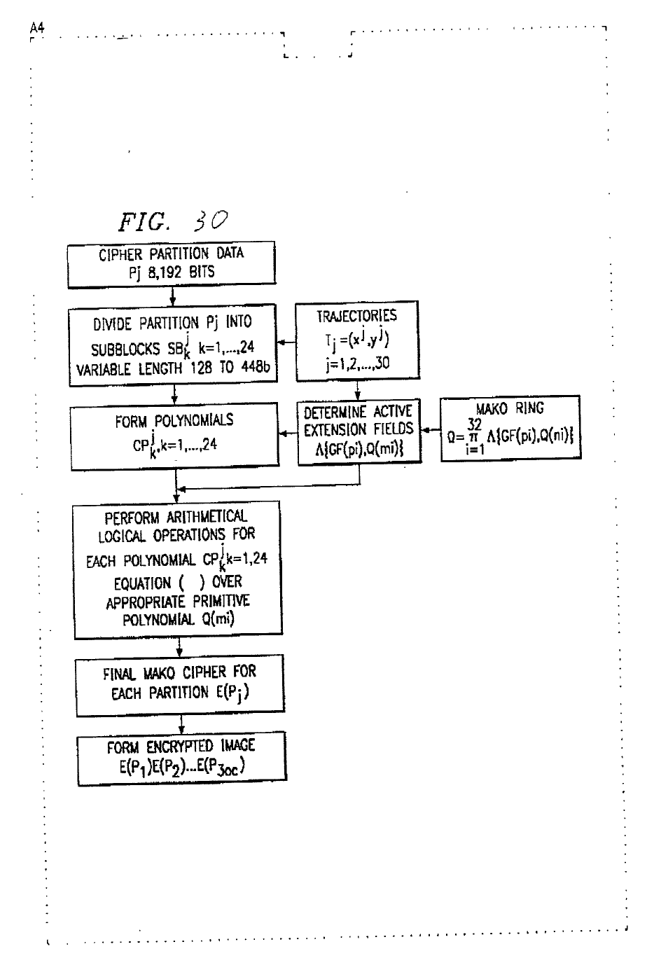

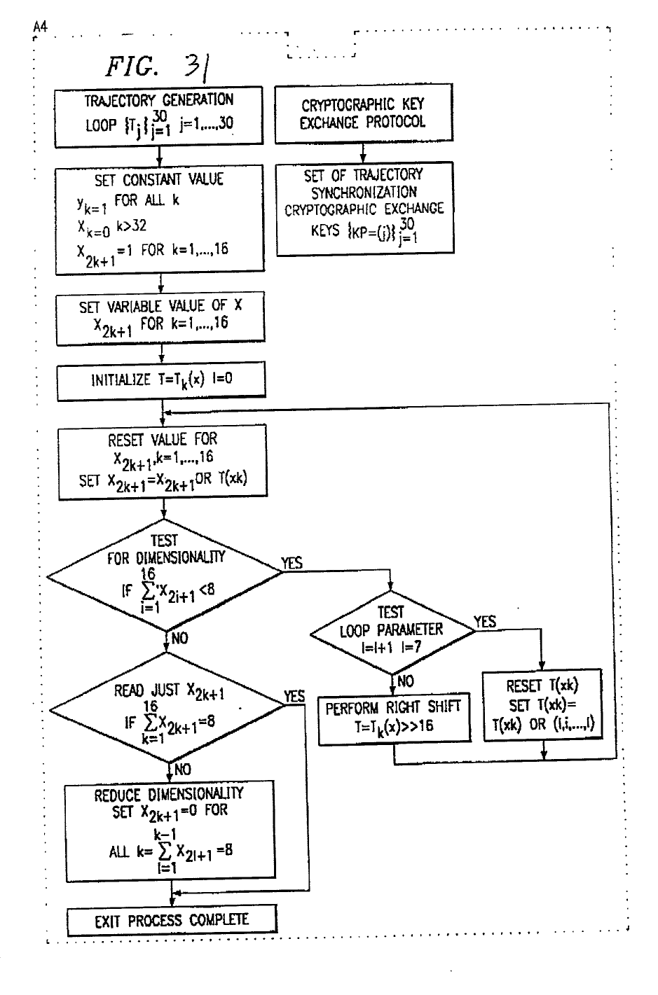

FIG. 3 is a flowchart illustrating initialization of camera 12. The method begins at step 60 where camera 12 is manufactured or sold by activator 18. The initialization of camera 12 may take place either initially during the manufacturing of camera 12 or at the point of sale of camera 12 to a consumer. After camera 12 has been sold, but before camera 12 is released to the customer, the method proceeds to step 62. Alternatively, after camera 12 is manufactured, but before camera 12 is distributed, the method proceeds to step 62. At step 62, a particular key 20 is assigned to camera 12. As noted previously, each key 20 is unique to a particular camera 12. The retailer or the manufacturer who is initializing camera 12 may select key 20 from a block of keys 20 assigned to that activator 18 by authorization center 14. Then, at step 64, serial number 22 is assigned to camera 12. Similar to key 20, serial number 22 may be selected by the retailer or manufacturer initializing camera 12 from a block of serial numbers 22 provided to that particular activator 18 by center 14 and associated with key 20. Serial numbers 22 are also unique to each camera 12. Then, at step 66, camera 12 is released from the retailer to the customer or distributed from the manufacturer. Then, at step 68, serial number 22 assigned to camera 12 is securely communicated from the retailer or manufacturer performing the initialization of camera 12 to authorization center 14 to inform center 14 that a particular pair of serial number 22 and key 20 are active and have been assigned to a camera 12. Serial number 22 may be communicated to center 14 over the Internet using public key/private key encryption. Alternatively, both serial number 22 and key 20 may be securely communicated to center 14. Key 20 and serial number 22 may be communicated to authorization center 14 using any suitable communication medium, such as wireline or wireless-based electronic transmission methods, by traditional hard copy methods, or by using any other transmission method.

In one embodiment, multiple authorization centers 14 may be available for use by verifying entity 16 and users of cameras 12, and the particular authorization center 14 used by the purchaser of camera 12 would need access to camera key 20 and serial number 22 associated with that particular user's camera. Key 20 and serial number 22 may be transmitted securely by encrypting key 20 and serial number 22 using public key/private key encryption. Alternatively, any suitable encryption scheme or other transmission scheme may be used to communicate key 20 and serial number 22 to authorization center 14 such that key 20 and serial number 22 are difficult to intercept during transmission.

FIG. 4 is a flowchart illustrating generation of encrypted image 28 by camera 12. The method begins at step 100 where a user (not shown) of camera 12 uses camera 12 to take a photographic image. The photographic image comprises a digital representation of a real-world scene such as image 27.

Next, at step 102, one or more items of embedded information may be added to digital image 27. Specifically, a time, serial number 22 and annotations 29 may be added to image 27. In order to provide increased security, a salt value may optionally be embedded in image 27. A salt value comprises a value added to a cryptographic key to provide increased security and increased difficulty in breaking the key. In the disclosed embodiment, the salt value may be used in order to increase the difficulty of forging an image to be authenticated by center 14 by adding additional information associated with the particular camera 12 which generated image 27. The salt value may also be used to distinguish different images 27 from the same camera 12, similar to picture counter 35. In addition, image 28 may be compressed in order to reduce the amount of storage 26 needed to store images 28 in camera 12. Then, at step 104, image 28 and the information embedded in image 28 are stored in storage 26. Proceeding to step 106, encrypted image 28 is generated. Encrypted image 28 is generated using the MAKO encryption and decryption algorithm described later in association with FIGS. 7-37. Then, at step 108, encrypted image 28 is stored in storage 26.

Then, at step 110, encrypted image 28 is transmitted to center 14. Encrypted image 28 may be communicated to center 14 by transferring encrypted image 28 to a general purpose computer, such as a personal computer (not shown) and then transferring encrypted image 28 to center 14 using the Internet. Alternatively, encrypted image 28 may be transmitted directly to center 14 using a wireless communication portion of camera 12. Also alternatively, encrypted image 28 may be communicated to center 14 using any wireless or wireline based communication system. Next, at step 114, center 14 receives and stores encrypted image 28 and associates image 28 with serial number 22 for later retrieval. Encrypted image 28 may be stored at center 14 as described in FIG. 2A.

FIG. 5 is a flowchart illustrating a method for verifying a digital image. FIG. 6 is a block diagram illustrating an exemplary use of system 10. FIGS. 5 and 6 are discussed together for increased clarity. The method begins at step 200 (FIG. 5) where verifying entity 16 (FIG. 6) desires authentication of an image 250 (FIG. 6) provided by a person 252 (FIG. 6). Image 250 comprises a unencrypted image to be verified by authentication center 14. For example, image 250 may comprise an image 27 taken by camera 12. Then, at step 202 (FIG. 5), the person 252 provides image 250 to entity 16 for verification. Proceeding to step 204, entity 16 provides image 250 to center 14. Image 250 may be encrypted by entity 16 using B-key 38 and communicated to center 14 over the Internet using public key/private key encryption. The serial number of camera 12 which took the original image is also provided to center 14.

Next, at step 206, center 14 decrypts encrypted image 28 associated with original image 250 using the decryption portion of the MAKO Algorithm. More specifically, person 252 indicates serial number 22 associated with camera 12 which originally captured image 250. Center 14 associates image 250 and encrypted image 28 by serial number 22 associated with camera 12 which generated encrypted image 28 and may also use a salt value associated with image 250. For example, as serial number 22 may be embedded within image 250, such as when image 250 comprises image 27, center 14 knows which encrypted image 28 to decrypt using key 30. For another example, the appropriate serial number 22 may be provided with image 250. The appropriate encrypted image 28 is then decrypted using the decryption portion of the MAKO Algorithm.

Once the original image 250 has been decrypted at center 14, image 27 recovered from encrypted image 28 is compared to image 250. Center 14 determines whether image 250 is indeed original image 27 by comparing every bit of image 250 to every bit of original image 27. Thus, any alteration from original image 27 to image 250 will be detected at center 14. If person 252 has altered image 250 so as to remove embedded text such as serial number 22, authorization center 14 may not be able to match up image 250 with an encrypted image 28, however, as image 250 is being submitted to center 14 in order to determine whether image 250 has been altered, this also indicates an altered image. Thus, authentication center 14 will determine that image 250 has been altered because image 250 has had its serial number 12 removed. Proceeding to step 208, a confirmation is provided to entity 16 regarding whether image 250 matches original image 27. Alternatively, authorization center 14 may send original image 27 to entity 16 so that entity 16 may compare original image 27 to image 250 itself. Also alternatively, center 14 may provide more than just confirmation as to whether image 250 matches original image 27, such as which parts of original image 26 or image 250 have been modified. The method then ends.

Alternatively, a key manager 254 (FIG. 6) may be used in association with step 204 (FIG. 5) for increased security. In this embodiment, image 250 is not communicated directly to center 14, but is set to key center 254. Key center 254 provides additional security by providing secure authentication credentials to entity 16 and center 14 to prevent, for example, man-in-the-middle impersonation schemes. For example, a man-in-the-middle may masquerade as center 14 and be associated with person 252 to provide false verification of image 250. Key center 254 may maintain secure links with entity 16 and center 14 in order to provide increased security.

FIGS. 7-37 illustrate the MAKO encryption algorithm itself. For clarity, some definitions are provided prior to the discussion of FIGS. 7-37.

Definition: A subgroup H of G is a subset of G that is a group under the operations of G. For example, the even integers are a subgroup of the group of integers.

Definition: A normal subgroup H of the group G is a subgroup of G that satisfies the following property (for purposes of this definition the group operation is written as a multiplication):

∀g G,gH g⁻¹=H

Definition: F is a field if F is a commutative group under both addition and multiplication.

Definition: R is a ring if R is a commutative group under addition and under multiplication obeys the associative and distributive laws. In the embodiment described in association with FIGS. 7-37, a field is assumed to be a ring, however, there exist fields which are not rings. For example, the ring of integers is a field which not a ring.

Definition: GF(p) is the Galois field for the prime number p. GF(p) is a field using modular arithmetic for both addition and multiplication.

Definition: A polynomial over a field is one that has its coefficients in that field. For example, consider a Field F, with aⱼ F for all j. Then P(x), as described in the following equation, is a polynomial over the field F:

P(x)=aₙxⁿ+aₙ₋₁xⁿ⁻¹+ . . . +aᵣx^{r}+ . . . +a₁x+aₒ

Definition: A polynomial P(x) is called irreducible if it has only itself and a scalar (element of the field) as factors.

Definition: Consider the set R of all polynomials P(x) of degree n or less than the field F. Now consider the irreducible polynomial Q(x) of degree n over the field F. Define operations addition and multiplication between pairs of polynomials as modulo Q(x). Then the set R is called an extension field of the field F.

The cryptographic algorithm MAKO comprises a variable length block cipher which employs two private cryptographic keys. The first cryptographic key is used in the development of ciphers from clear text imagery data. The second is used to develop synchronization for the determination of trajectories which are employed to increase the overall efficiency of the cryptographic algorithm. MAKO is also asymmetric in the sense that the number of processing operations required to encrypt a given block size is substantially less than the number of processing operations required to decrypt that same block of data. This is shown by the following equation:

(0)nopsₑ<<nops_{d}

System 10 supports the verification of authenticity of each bit of each pixel of a digital camera's image. However, MAKO is also applicable to the encryption of other forms of digital imagery, graphics and textual data. The functionality of MAKO within the Trusted Digital Camera system was described in FIG. 2.

As is illustrated by FIGS. 2 and 8, in one embodiment, the encryption segment of the cryptographic algorithm MAKO may be resident on CPU 24. The decryption segment of the cryptographic algorithm MAKO resides within authorization center 14, to support the decryption functionality. Upon demand by entity 16, authorization center 14 uses MAKO to decrypt an encrypted image 28 to determine the image's authenticity through the verification of each bit of every pixel of the digital image. Authorization center 14 may then report these results back to entity 16.

An overview of the encryption segment of the cryptographic algorithm MAKO is illustrated in FIG. 9. As is illustrated there, MAKO may be used to encrypt blocks of imagery data. A more detailed overview of the encryption portion of MAKO is illustrated in FIG. 10.

A partitioning function divides the image data into appropriate blocks of imagery data which can then be encrypted with a single pass through MAKO. The functionality of the partitioning function is described in FIG. 11 according to one embodiment of the present invention. The variability of the lengths of the blocks of imagery depend on such factors as camera design, size of original imagery data plus embedded text, if any; data word length of the host microprocessor, and system design constraints for a given system, such as system 10. The partitioning function divides the original pixels of the clear text image 27 (an unencrypted digital image produced by camera 12) into appropriate size blocks for MAKO. In addition, it divides the embedded or appended textual data into separate partition boxes suitable for the MAKO encryptor portion in camera 12. The size of each block is variable between a minimum and maximum block sizes, Pₘᵢₙ and Pₘₐₓ, respectively. The dimensions of a block are dependent on the length of the cipher cryptographic key, K₁. These relationships are as follows: (1) Pₘᵢₙ<1(K₁), where 1(K₁) is the bit length of the cipher cryptographic key; and (2) Pₘₐₓ<(n) (1(K₁), where n is the dimensionality of the product space or rings used in the S₂ box (show in more detail in association with FIG. 30). If a partition is less than the minimum block size, Pₘᵢₙ, then additional bits are added at the end of the partition by using the available salt which may be derived from camera and microprocessor peculiar data (a salt was previously described in association with FIG. 4).

MAKO employs two separate cryptographic keys. Both of these keys are private and typically are resident onboard the microprocessor of camera 12 and securely stored within the center's 14 database of user cryptographic keys. The transmittal and implanting of these cryptographic keys may be performed in a suitable manner. As is shown in FIG. 12, both cryptographic keys undergo key exchange protocols before being used in the encryption process. Cameras 12, in one embodiment, may be involved with the authentication of financially sensitive data and, as such, require cryptographic key lengths of at least 128 bits. MAKO may accept cryptographic key lengths from 32 bits up to 512 bits. The cryptographic key for producing cipher data is denoted by K₁ and the cryptographic key used for producing synchronization data for the trajectories is denoted by K₂. The lengths of these cryptographic keys are denoted by 1(K₁) and 1(K₂) for the cipher cryptographic key and the trajectory cryptographic key, respectively. As illustrated in FIG. 12, in one embodiment, the salt data may be developed from onboard digital camera system data such as: microprocessor system clock, date and time of image capture, digital camera serial number, and other data stored onboard the microprocessor. The length of the salt data is as follows: 1(SDj)=1(Kj), for j=1,2. This salt data is then fed into two separate processing paths, one for the cryptographic key exchange for the cipher cryptographic key and the other for the cryptographic key exchange for the trajectory synchronization cryptographic key. Salt ciphers are developed by sending the salt data through a non-linear feedback shift register and then a rotation matrix. The non-linear feedback shift register, of length 1(SDj) may comprise a suitable non-linear feedback shift register with selectable taps and arithmetic logic. The rotation matrix is a matrix which rotates all of the nibbles in the salt cipher product and is illustrated in FIG. 13. More specifically, rotation matrix=R(Sⱼ) where Sⱼ is an element of S(Nₗₐₛₜ+1) and where Nₖ is incoming and Nₛⱼ₍ₖ₎ is outgoing for k=0, 1, 2, . . . 1(SDⱼ)−1.

In one embodiment, different non-linear feedback shift registers and rotation matrices are used for the two separate cryptographic key exchange protocols. Different numbers of cryptographic key exchanges are used for the cipher and trajectory synchronization cryptographic key exchange protocols. These are determined as part of the design of the S₂ and are precomputed and serve as exogenous inputs to the cryptographic key exchange protocols.

The actual encryption segment for the cryptographic algorithm MAKO consists of three subsegments: P, S₁ and S₂. The P box is a linear mixing and randomization box using a combination of permutations from S[1(K₁)], which is the permutation group on 1(K₁) symbols, and a rotation matrix which is an element of S[1(K₁)/4] as is illustrated in FIG. 14. This procedure is reiterated for a predetermined number of rounds. The purpose of the P subsegment is to achieve the first order of bit smoothing and randomization of the incoming block of clear text imagery data.

The data emerges from P and enters the first non-linear segment, denoted as S₁. As is shown in FIG. 15, the S₁ box uses a combination of Non-linear Feedback Shift Registers (see, for example, FIGS. 29, 35 and 36), a nibble twiddle function, and one or more nibble rotations to achieve a second level of bit smoothing and randomization of a block of imagery data.

FIGS. 35, 36 and 29 respectively illustrate exemplary embodiments of non-linear feedback shift registers (NLFSR) number one (#1), number two (#2) and number three (#3). Note that in the illustrated examples of the non-linear feedback shift registers, a 128-bit block is used where the high or left-most nibble is denoted R31 and the low or right-most nibble is denoted R0.

With respect to FIG. 29 and NLFSR number three, in operation, bit A1 is replaced by bit A128, bit A128 is replaced by bit A1. Next, bit A23 is replaced by A5ˆ A7ˆ A23 and bit A91 is replaced by A14ˆ A43ˆ A112 (where the “ˆ ” symbol indicates the XOR operation). Finally, the resultant cipher is left circularly shifted 17 bits, such that the new A1 becomes A18, the new A2 becomes A19, the new A128 becomes A17 and so on.

With respect to FIG. 35 and NLFSR number one, in operation, bit A11 is replaced by bit A111, bit A111 is replaced by bit A11. Next, bit A63 is replaced by A15ˆ A97ˆ A123 and bit A51 is replaced by A59ˆ A93ˆ A102. Then, the resultant cipher is left circularly shifted 17bits, such that the new A1 becomes A18, the new A2 becomes A19, the new A128 becomes A17 and so on.

In FIG. 36, with respect to NLFSR number two, in operation, bit A11 is replaced by bit A111, bit A111 is replaced by bit A11. Next, bit A63 is replaced by A15ˆ A97ˆ A123 and bit A51 is replaced by A59ˆ A93ˆ A102. Then, the resultant cipher is left circularly shifted 17 bits, such that the new Al becomes A18, the new A2 becomes A19, the new A128 becomes A17 and so on.

Returning to FIGS. 14 and 15, the number of rounds incurred in both P and S₁ are dependent on the overall design of the encryption scheme and its intended usage. Thus, the extent, specific design parameters and size of the round are design dependent. The following factors are also specific to a particular embodiment of the MAKO cryptographic algorithm, and may depend on the tuning characteristics used to reach the required levels of both randomness and smoothness: (1) number of rounds for S₁; (2) maximum number of twiddles; (3) specific design for non-linear feedback shift register #3; (4) specific design for non-linear feedback shift register #4; (5) specific test of procedures for selecting and testing a nibble within the twiddle loop; (6) size and composition of the MAKO table; (7) specific design for modification of selected nibble when nibble test succeeds; and (8) specific design for the rotation matrix. For example, non-linear feedback shift register #4 may be designed based on non-linear feedback shift registers number one, two and three, or may use another suitable design.

In the S₁ box, incoming blocks of cipher data are sent forth through non-linear feedback shift register #3 (see FIG. 29) and then through the twiddle loop for a predetermined and constant number of rounds. The twiddle loop consists of selecting a nibble from the incoming cipher data and then testing it against an entry in the MAKO Table (see FIG. 32). The MAKO Table comprises one or more hexadecimal entries and has an allowable size range of 32 by 32 up to a maximal size of 512 by 512. If the test fails, then another round for S₁ is started. However, if the test succeeds, then a predetermined procedure is used to modify the previously selected nibble. Following this, the ciphered data is sent through non-linear feedback shift register #4 and then a rotation matrix which permutes the nibbles contained in the cipher data. Following this a test is made for the maximum number of allowable twiddles. If the maximum number of twiddles is reached, then the number of rounds completed is tested. If less than the maximum number of rounds has now been processed, then a new round for S₁ is initiated. However, if the maximum number of rounds has now been processed, then the enciphering process for S₁ is completed. It should be noted that all of the cryptographic procedures involved in both the P box and the S₁ box may be modified based on the overall implementation for MAKO required to achieve specific system design and tuning requirements.

A general overview of the S₂ box is contained in FIG. 16. First, at step 1600, the correct trajectory is selected. Next, at steps 1602 and 1604, the trajectory is used to determine the ring for the operations as well as the active bits in the incoming cipher data. Once the correct ring and correct bits have been identified, then the correct arithmetical and logical operations are applied to the incoming cipher data at steps 1606, 1608 and 1610. The resultant is the enciphered data from the S₂ box. In general, it uses logical arithmetic operation over extension fields of the Galois Fields, GF(p^{m}), where p is a Mersenne prime and the extension field is generated by a primitive polynomial with coefficients in GF(p). In the following, a brief discussion of cyclotomic polynomials over these fields together with the notation used in the sequel in presented to increase the clarity of the discussion of the cryptographic algorithm contained in the S₂ segment.

For increased clarity, a general description of the mathematics of cyclotomic polynomials and notation used in the description of one embodiment of MAKO is provided. The factorization of uⁿ−1 over the complex number C is given by the following equation:

$${u}^{n} - 1 = {\prod }_{j = 0}^{n - 1} ( u - {ω}^{j} ) \qquad ( 1 )$$

where ω^{j}=e^{-2x}ij/n. The polynomial u−ω^{j} are called cyclotomic polynomials and form the basis for their generalization to fields, extension fields, and rings of interest. More specifically, the fields, GF(p) and their extension fields are considered. The cyclotomic polynomials over the rational numbers, Q, are given in equation (2) and the factorization of uⁿ−1 in terms of these cyclotomic polynomials is given by equation (3).

$${C}_{d} ( u ) = {\prod }_{( r , d ) = 1} ( u - {ω}_{d}^{r} ) \qquad ( 2 )$$

where ω_{d} is a d-th root of unity.

$${u}^{n} - 1 = {\prod }_{d / n} {C}_{d} ( u ) \qquad ( 3 )$$

GF(q) is an extension field of GF(p) where q=p^{m}, and with P(v) being an irreducible polynomial with coefficients in GF(p) and the arithmetic in GF(q) being performed modulo P(v). In the following, we will concentrate our attention on spaces formed from GF(p) and the extension fields GF(q). Definitions are provided for clarity.

Definition: For A, a non-zero element of GF(q), the smallest non-zero integer, n, such that Aⁿ=1 is called the ORDER of A. We note that n<=q−1.

Definition: An element in GF(q) having order equal to q−1 is called a PRIMITIVE ELEMENT of GF(q).

GF(q) has a primitive element, in fact in somewhat of abundance. The following factorization of u^{q-1} over GF(q) may be made where A is a primitive element of GF(q).

$${u}^{q - 1} - 1 = {\prod }_{i = 0}^{q - 1} ( u - {A}^{i} ) \qquad ( 4 )$$

The set Γ={1,2, . . . ,q−1} containing the powers of the non-zero elements in GF(q) is partitioned into subsets Γⱼ₁Γⱼ₂, . . . A cyclotomic set Γⱼ begins with j, where j is the smallest power of A not included in the preceding subsets. Other elements in the subset Γⱼ obtained as follows:

Γⱼ={j,jp,jp²,jp³, . . . }. (5)

Since A^{q-1}=1, the powers of A are defined mod q−1=p^{m}−1. Also, where q=p^{m}, A^{q-1}=1 implies that A^{jq}=A^{j}. Therefore, there are at most m elements in each Γⱼ. No elements in the two different cyclotomic sets are equal. Let Ψ be the set of indices j₁, j₂, . . . Based on this partitioning and equation (5), the factorization of U^{q-1} as follows:

$${u}^{q - 1} - 1 = {\prod }_{j ϵ ψ} \{ {\prod }_{{θϵΓ}_{j}} ( u - {A}^{θ} ) \} = {\prod }_{j ϵψ} {Q}_{j} ( u ) \qquad ( 6 )$$

In the above equation, the polynomials Q(u) are defined as follows:

Qⱼ(u)=(u−A^{j})(u−A^{jp})(u−A^{JP}^{²}) . . . (u−A^{JP}^{¹⁻¹}) (7)

where it is true that the following holds: jp¹≡jmod(p^{m}−1)

Definition: An irreducible polynomial over GF(p) having a primitive element, A, of GF(p^{m}) as its root is called a primitive polynomial.

MAKO uses extension fields generated by primitive polynomials as the bases for its logical arithmetic calculations. The Galois Field extension generated by the primitive polynomial, Q(mj) over the Galois Field GF(pⱼ) is denoted by Λ[GF(pⱼ), Q(mⱼ)]. The ring over which the cryptographic algorithm MAKO operates is denoted by Ω and is defined by the following equation.

$$Ω = {\prod }_{i = 1}^{N} Λ \{ GF ( {p}_{i} ) , Q ( {m}_{1} ) \} \qquad ( 8 )$$

In equation (8), N is the dimensionality of cryptographic algorithm MAKO which ranges from 1 to 256. Elements of Ω can be regarded as sequences such as (x₁, x₂, . . . , xₙ), where each xⱼ ε{GF(p^{j}), Q(m^{j})}. Each trajectory, Tₖ, consists of an ordered pair as follows: Tₖ=(x,y), where x=(x₁, x₂ . . . , xₙ), with N′<=N and y=(y₁, y₂, . . . , yₖ₍ₖ₁₎, and each xⱼε{1,N} and each yⱼε{0,1}. A trajectory is used by MAKO to determine which subrings of Ω are active and which bits of each subblock are active for the partition now being encrypted.

Also, with respect to Equation (8), consider the fields Fⱼ, for j=_{1,}. . . n. We define a product space F as follows. Definition: F is the product space of the fields Fⱼ, for j=1, . . . n if all arithmetic operations are performed coordinate wise. Thus, write F as follows:

$$F = {\prod }_{j = 1}^{n} {F}_{j}$$

and define multiplication on addition as follows: If z=(x₁, x₂, . . . , xₙ) and w=(y₁, y₂, . . . , yₙ) are elements of F, the multiplication and addition are defined coordinate wise as described by the following sets of equations.

z+w=(x₁+y₁x₂+y₂, . . . , xₙ+yₙ)

z·w=(x₁y₁x₂y₂, . . . , xₙyₙ)

Note that if all of the Fⱼ, for j=1, . . . , n are fields, the F is also a field under the above definitions for its arithmetical operations.

For each trajectory, Tₖ, the first ordered pair, x, is defined in the following discussion. Each x is an ordered subset of the set of integers {1,2,3, . . . , N}. Order is important and, therefore, the two subsets {1,2,3} and {3,1,2} are regarded as different in MAKO. FIG. 12 illustrates a methodology by which MAKO uses a trajectory to determine how to apply specific logical arithmetical operations for a specific extension field. As is shown there, each cipher block consisting of (M) (1(K₁) bits is divided into M segments. First, we define

$${}_{1} = [ {p}_{{n}_{i}^{k}} / 2 ] [ {m}_{{n}_{1}}^{k} + 1 ] .$$

If the bits are enumerated from left to right starting with bit 0 and ending with bit (M) (1(K₁)−1, then the first segment consists of the bits 0,1, . . . , ₁−1. The second segment consists of the bits _{1, 1}+1, . . . , _{1, 2}+1. The last segment consists of the following bits:

$${\sum }_{l = 1}^{M - 1} {1}^{′} {\sum }_{l = 1}^{M - 1} 1 + 1 , … , ( M ) ( 1 ( {K}_{1} ) - 1.$$

In each trajectory, the second ordered pair, y, is used to determine the bits of each subblock within the cipher block that are active for the encryption of a specific partition. The composition of y is predetermined and depends on design constraints specific to the application of MAKO.

The trajectories are generated using the trajectory synchronization cryptographic key exchanges previously discussed. During this key exchange protocol the appropriate number of trajectory synchronization cryptographic key exchanges were computed. This process involved the trajectory synchronization cryptographic key and the SALT. Each trajectory, Tₖ(x,y), is generated using the process described in FIG. 17. In that diagram, K₂Xₖ for k=1, . . . ,N_{sg} represents the exchanged trajectory synchronization cryptographic keys previously developed. In addition, N_{sg} represents the number of super groups for a specific embodiment of MAKO, and is dependent on the total size of the image data, the minimum and maximum partition sizes selected for a specific implementation of the cryptographic algorithm MAKO. As is shown in FIG. 17, the system design parameters have led to both the partitioning of the original clear text image and the number of trajectory synchronization key exchanges required to be produced by trajectory synchronization key exchange protocol. That number is twice the number of super groups or 2N_{sg}. The number of supergroups is a system design constraint and is constant for a given embodiment of MAKO. The set of trajectory synchronized exchanged cryptographic keys, {K₂Xₖ}ₖ₌₁^{2N}^{_{sg}}, are then used in combination with a preselected (and MAKO system implementation specific) set of procedures involving arithmetical and logical arithmetical operations. It determines which of the specific field extensions are active in each trajectory and which bits of the cipher are active for each trajectory. The final step in the procedure is to assign a specific trajectory to each partition.

It is an option to use either a suitable existing cryptographic algorithm or a subset of MAKO for the generation of hashes for each of the trajectories. The hashes thus produced are denoted as {ETk}, for k=1, . . . ,N_{sg}. These are then appended to the encrypted image and text data for use in the decryption segment of the cryptographic algorithm MAKO. The incoming bits in the imagery data are then segmented as described above by the trajectories. They become the coefficients of a polynomial over GF(pⱼ) with order equal to mᵢ. Using the following polynomial as a model, we then ascribe how the coefficients are determined.

aₘ·u^{m}+aₘ₋₁·u^{m-1}+ . . . +aₘ₋ᵣ·u^{m-r}+ . . . +a₁·^{u}+a₀ (9)

Each of the coefficients aⱼ consists of precisely p/2 bits. If any of the pⱼ are odd, then the total number of such odd prime numbers in each trajectory must be an even integer. The coefficients are then packed from left to right beginning with aₘ and ending with a₀.

The cipher computation is next in MAKO. Admissible logical arithmetic and arithmetic computations include +, −, *, /, log, exp, exclusive or, inclusive or, not, and convolution and acyclic convolution. All of these operations are applied modulo, the appropriate primitive cyclotomic polynomial. The resultant coefficients are the ensuing cipher in the order as described above in equation (2). Appended to the ciphers for the imagery data are the synchronization bits for the trajectories. The minimal number of logical arithmetic operations is dependent on the M+1. Typically, the minimum number of logical arithmetical operations is 4.5×(M+1).

Several techniques are known classically for efficient computations over product spaces of extension fields of Galois Fields. One such example is the FFT (Fast Fourier Transform) which is an efficient version of the Discrete Fourier Transform. Dependent on the specific design used in the MAKO algorithm a fast computational version for the computation of the logical arithmetic operations would be employed in MAKO.

The decryption algorithm associated with the cryptographic algorithm MAKO is asymmetric to the encryption algorithm. The decryption algorithm, in one embodiment, requires substantially more processing time that does the encryption algorithm. An overview of the decryption algorithm for MAKO is contained in FIG. 18. At steps 1200 and 1201 system design data is used to reconstruct the partitioning involved in the early stages of the encryption segment of the cryptographic algorithm MAKO. These design parameters include the one or more of the following: (1) clear text image size in bits; (2) length of the cipher cryptographic key; (3) dimensionality of the S₂ box of MAKO, which is the number of extension fields involved in the direct product for the S₂ ciphering algorithms; and (4) minimum and maximum dimensions of the partitioned subsets of imagery data. Given these inputs, it is feasible to recalculate the partitioning accomplished in the initial states of the encryption segment of the cryptographic algorithm MAKO. Once this is accomplished, the decryption algorithm of MAKO contains the exact partitioning {Pⱼ} that the encryption segment of MAKO used for the encryption process. Next, at step 1202, the incoming encrypted data is divided into the following segments: (1) encrypted imagery; (2) encrypted trajectory synchronization data; (3) encrypted salt data, E[SD₁]; and (4), encrypted textual data. Note that given the dimensions of items 1 through 3, all of these data items are separateable. Therefore, the data resultant from the encryption of the textual data is that data that remains.

Next, at step 1204, the decryption of the encrypted version of the salt associated with the cipher cryptographic algorithm is performed. As previously discussed, the salt was associated with SD₁ and was encrypted. The encryption of the salt was accomplished by using the cipher cryptographic key, K₁, the special trajectory T·, and a subset of the MAKO encryption algorithm consisting solely of the S₂ box. The decryption only uses T·, the cipher cryptographic key, K₁, and the S₂ box. The S₂ box has the same or greater cryptographic strength as in the rest of the MAKO algorithm.

The output of step 1204 is the entire set of all cipher cryptographic key exchanges developed in the early segments of the encryption segment of MAKO. The set of exchanged keys is given as follows: {CⱼK₁}ⱼ₌₁^{nc max} where as in the previous discussions, ncmax represented the total number of cryptographic key exchanges required of the cipher cryptographic key, K₁.

At step 1206, the methodology of reconstruction of the trajectories that were employed in the encryption of the imagery and textual data in the encryption segment of MAKO are described. All or substantially all of the trajectories used in the encryption segment of the cryptographic algorithm MAKO should be known to the decryption segment of the cryptographic algorithm MAKO before it can decrypt the image and textual data that was encrypted by the encryption segment of MAKO.

FIG. 19 presents further details of the methodology employed at step 1206 by the decryption segment of MAKO to reconstruct the trajectories employed in the encryption of the image and textual data by the encryption segment of the MAKO cryptographic algorithm.

At steps 1300 and 1302 the methodology for trajectory reconstruction involves assembling substantially all feasible trajectories. Technically feasible in this sense means that within the constraints of the system design constraints, a trajectory is indeed technically feasible. Appropriate system design constraints are known to the decryption segment of MAKO, therefore, it can complete a set of technically feasible trajectories, which we denote in step 1302 by {TFₖ}. The trajectory synchronization data was computed using the S₂ box of MAKO, together with the trajectory T· and the cipher cryptographic key, K₁. Therefore, all of the technically feasible trajectories, {TFₖ} are subjected to the same encryption process to produce their encrypted versions, which we denote in step 1304 by {ETFₖ}. These are then compared with the set of all encrypted trajectory synchronization data, denoted as previously disclosed by {ETₖ}ₖ₌₁^{N}^{_{ng}}. Those indices for which the ETFₖ exactly equal some ETⱼ, for j=1, . . . N_{sg} uniquely identify a trajectory employed in the original encryption segment of the cryptographic algorithm MAKO. Therefore, the decryption algorithm of MAKO builds a set of these trajectories, resulting in the complete set of trajectories, {Tₖ}ₖ₌₁^{N}^{_{ng}} used by the encryption segment of the cryptographic algorithm MAKO. This is successively routed through all combinatorial possibilities for trajectories until the unique correct trajectory is determined. If there are M total number of extension fields in the direct sum that the cryptographic algorithm MAKO uses for encryption and precisely n of these are active and technically feasible for the partition size, then the decryption algorithm for MAKO must consider pₙ^{M} possibilities. This is number of permutations of M symbols taken n at a time. This makes the MAKO cryptographic algorithm asymmetric. This is what the decryption segment of MAKO uses to decrypt the image and textual data that was previously encrypted by MAKO.

Returning to FIG. 18, the encrypted image and textual data can now be sent through the reverse MAKO algorithm which comprises steps 1240, 1242 and 1244: (1) Reversed S₂ box; (2) Reversed S₁ box; and (3) reversed P box. Reversing comprises applying substantially similar operations as in the original, but in the reverse order. For example, the reversed P box may comprise the same steps as the normal P box, but applied in reverse order. It should be noted that all of these ciphering boxes are uniquely invertible. Therefore, this decryption process produces uniquely the exact clear text or image and textual data that was used to produce the encrypted image and textural data. The encryption segment of MAKO uses polynomial time for its encryption processing of block cipher data. On the other hand, the decryption segment of MAKO uses both exponential processing time in the reversed S₂ box and reversed S₁ box, coupled with strong combinatorics in the trajectory reconstruction methodology. In one embodiment, this produces a very strong asymmetry between the number of processing operations required to encrypt the image and textual data as compared to the number of processing operations required to decrypt the previously encrypted blocks of image and textual data.

In an exemplary embodiment of MAKO, MAKO is configured for use with system 10. This exemplary embodiment is designed for still digital camera imagery with 1,024,000 pixels each of which consists of 24 bits. Thus, the total number of bits in the digital imagery which is to be encrypted includes 24,576,000 bits. Both the cipher cryptographic key and the trajectory synchronization cryptographic key are 128 bits long. This is currently regarded as safe and conservative to protect financially sensitive data under the assumption that the cryptographic algorithms employed are not vulnerable to any cryptanalytic attacks other than the traditional brute force method of examining each value of the cryptographic keys to determine if the decrypted version of the encrypted imagery data using that value for the cryptographic key matches a predetermined clear imagery text. Thus, if MAKO is only vulnerable to this type of cryptanalytic attack, that the adversary would have to perform 2¹²⁸ computations of the complete MAKO cryptographic algorithm, which includes the P, S₁, and S₂ boxes. This translates into having the adversary make over 3.4×10³⁸ computations. Assuming that the adversary has the fastest algorithm available for processing MAKO, then a single 1 Ghz computer would use 1 microsecond per computation. Thus, if the adversary had $10,000,000 in resources and could acquire 5000 such machines and successfully organize them in a coordinated key space attack, it would take this quite formidable adversary about 6.8×10²⁸ seconds or 2.15×10²¹ years to successfully insure a complete key space break of any single still imagery data encrypted by the MAKO cryptographic algorithm when equipped with a cryptographic key of 128 bits and provided with the appropriate level of cryptographic security for its synchronization of the trajectories employed in the encryption mode of MAKO. In general, the length of the cryptographic key may be selected based on various considerations, such as the amount of time and money an adversary would devote to attacking the encryption and the importance of the data.

FIG. 20 presents an overview of this exemplary embodiment of the encryption side of MAKO. System 10 allows for a wide range of textual and digital speech data to be appended to or embedded within the original, unencrypted imagery captured by the still digital camera. However, it is assumed for this example that the incoming clear text digital imagery consists of 1,024,000 pixels, each of which consists of exactly 24 bits. Current digital still cameras use 24 bit pixels consisting of a RGB color system with each of the red, green, and blue components consisting of 8 bits each. MAKO is designed to encipher bits in a block cipher mode, therefore, it does not consider the color content of the pixels in its encryption process.

The first step in the encryption mode of MAKO is to partition the imagery data into partitions which then can be encrypted in a single pass through the MAKO algorithm. In this embodiment, the original clear text image of 1,024,000 pixels is subdivided into 3,000 partitions, each of which consist of 8,192 bits. FIG. 21 illustrates the enumeration scheme of each digital image. It depicts a general approach of enumeration starting in the upper left hand corner and proceeding in a raster scan pattern to the lower right hand corner. The bits of each pixel are then enumerated in a flat file as is also shown in FIG. 21. FIG. 22 describes the partitioning step of FIG. 20. As is shown there, the original digital image has been subdivided into 3,000 partitions, each of which consists of 8,192 bits.

MAKO uses two private keys. One set of keys is embedded in the microprocessor of the digital camera upon purchase by the user. The other set is securely transmitted and securely stored in authentication center 14. Both of these cryptographic keys are 128 bits in length. One of the cryptographic keys is for producing ciphers while the other cryptographic key is used in the generation of synchronization data used in development of trajectories for both encryption and decryption. Both of these cryptographic keys undergo separate cryptographic key exchange protocols before their actual usage in the cryptographic algorithm MAKO. In this embodiment of MAKO, 64 distinct cryptographic key exchanges are used for the cipher cryptographic key. For the synchronization cryptographic key, a total of 60 distinct cryptographic key exchanges are used. FIG. 23 presents a functional block diagram of the cryptographic key exchange protocols for both the cipher and synchronization cryptographic keys. MAKO, in one embodiment, uses at least 128 bits for its salt. Within system 10, this salt may be derived from data such as camera serial number, manufacturer's identification number, and the microprocessor's clock. If these data by themselves do not produce at least 128 bits, then a non-linear dithering process may be used to extract additional salt data from successive readings of the microprocessor's system clock. The cryptographic key exchange protocol is the same for both the cipher cryptographic key and the synchronization cryptographic key. Both the salt and cryptographic key undergo 8 rounds of bit randomization and smoothing. This is accomplished by passing them successfully through non-linear feedback shift registers and a nibble rotation matrix. After completion of this processing, the resultant cipher forms for the salt and the cryptographic key and are then xor'ed together to complete the cryptographic key exchange protocol. Note that the symbol “ˆ ” may be used in indicate the XOR operation.

Each partition, {Pⱼ}ⱼ₌₁³⁰⁰⁰, is then sent in succession through the MAKO encryption process. The first stage in this process is the P box. Each partition, Pⱼ, consists of 8,192 bits of 64 subblocks of 128 bits each. Each subblock is sent through the P box in successive order and the outputs are then concatenated to form a processed block of data consisting of 8,192 bits. This process is depicted in FIG. 24. Each subblock first undergoes a permutation, σε S(128), and then is routed through a nibble rotation box, R₃, which is depicted in FIG. 25. In FIG. 24, ( . . . ), is used to indicate the interchange of bits. For example, (64 65) means that the 64^{th} and 65^{th} bits are interchanged. In FIG. 12 each of the Rj are one nibble, that is to say 4 bits. The table in FIG. 25 describes the rotation of nibbles in each 128 bit subblock of a partition. The functionality of the P box is to provide initial smoothing and introduce randomness to the incoming partitions of imagery data.

Next the data is sent through the S₁ box as illustrated in FIG. 26. Each of the 64 subblocks of data consisting of 128 bits each are sent through the S₁ in successive order. Before proceeding with the description of the procedure involved in the S₁ box, a discussion of the nomenclature is provided for increased clarity. FIG. 27 illustrates the enumeration of nibbles for each 128 bit block of cipher data that is incoming to the S₁ box. As is shown in FIG. 27, the nibbles are enumerated starting with nibble N1 and ending with nibble N31 commencing with the lower ordered bits. The nibble that is tested in the twiddle factor for MAKO has a basis of N5. The selected nibble is determined by the index of the subblock modulo 16. The method used to compute the actual nibble used for the twiddle factor is to take the subblock index K and add it to 5 modulo 16. This equation is as follows: Nibble index=(K+5) modulo 16. This original nibble is kept for additional testing throughout the twiddle procedure. The testing procedure is to compare the incoming cipher's N5 against the selected nibble comprising the first hexadecimal number in the MAKO TABLE of FIG. 32 to determine if they are equal. If they are equal, then the procedure is completed. If they are not equal, then the procedure continues. First, a two bit circular left shift is applied to the selected nibble and then it is incremented by 1 modulo 16. This procedure is called out in FIG. 22. The next step in the procedure is to apply the non-linear feedback shift register number 3, which is depicted in FIG. 23. Following this step the resultant cipher data is processed through the rotation process of Rotation Matrix R4 which is illustrated by FIG. 37. This concludes the cipher processing involved in the S₁ box.

An overview of the processing involved in the S₂ box is contained in FIG. 30. As there are a total of 30 supergroups in this embodiment of MAKO, the trajectories comprise a total of 60 128-bit words. Thirty data words describe the selection of the indices in the product ring and the remaining 30 data words describe the active bits for enciphering. In this embodiment of MAKO, all of yₖ=1. For the x vector, we have the following xk=0 for k>32. Then x₂ₖ₊₁=1 for k=1, . . . ,16. The values of the X₂ₖ for k=1, . . . ,16 are determined for the key exchanges of the trajectory synchronization cryptographic key. First, a total of precisely eight values for these where xₖ=1 is determined. This procedure is depicted in FIG. 31. As is illustrated there, the first 16 bits of the exchanged synchronization key are used to set the values for these xₖ. If at least 8 are nonzero, then all of the remaining xₖ after the eighth nonzero entry are set to zero and the process terminated. If fewer than 8 are nonzero, then the next 16 bits are continued to determine if they produce any additional nonzero entries for the xₖ. This process continues until the process terminates or exhausts the 128 bit synchronization key. If the latter happens, the 128 bit synchronization key is XOR'ed with all 1's and the process resumes. This forces the process to eventually terminate. The resulting path data are then sent through the S₂ for the first supergroup to produce ciphers which are then appended to the ciphered imagery data as synchronization data for the decryption segment of MAKO.

The ring over which the cryptographic algorithm performs its logical and arithmetic operations is denoted by and defined as follows:

$$Ω = {\prod }_{i = 1}^{32} Λ \{ GF ( {p}_{1} ) , Q ( {m}_{i} ) \} \qquad ( 10 )$$

In equation (10), the degree of MAKO is 32. In addition for j=1, . . . ,16 the following relationship holds: {GF(p₂ⱼ₊₁), Q(m₂ⱼ₊ₜ)}={GF(7), Q(128)}. In addition for j=1, . . . ,16 the following relationship holds. (GF(p₂ⱼ), Q(m₂ⱼ))={GF(2), Q(128)}. There are a total of 24 active indices for the direct product of the extension fields. Within this total of 24, all of the odd indices from 1 to 31 are active and only 8 of the even indices from 2 to 32 are active. Let A be the smallest primitive integer in GF(p^{m}). Let the cyclotomic set ⱼ be defined by the primitive element A. Then because the following equation holds true:

$${u}^{q - 1} - 1 = {\prod }_{j ϵ ψ}^{} {Q}_{j} ( u ) \qquad ( 11 )$$

where q=p^{m}, all of the Qⱼ(u) are primitive polynomials. Furthermore enumerate in ascending order the indices contained in as follows: ={j₁, j₂, . . . jₖ, . . .}. The cardinality of >>16 as each cyclotomic set has at most m members. Therefore, for j=1, . . . , 16 we have the following for the primitive polynomials:

Q₍₂ⱼ₊₁₎_{ₖ}(u)=Qⱼ_{₁}(7),k=1, . . . 16 (12)

Q₂ⱼ_{ₖ}(u)=Qⱼ_{₁}(2),k=1, . . . ,16 (13)

The logical arithmetic operations are the same for both primitive polynomials. For KE is the exchanged cryptographic key, SE is the exchanged SALT data, C is the incoming cipher data, and CIRCLS^{k} represents a circular left shift of k bits, we have the following operation:

KEˆ SEˆ Cˆ CIRCLS⁷(C)ˆ CIRCLS¹⁷(C)ˆ CIRCLS²⁹(C)ˆ CIRCLS³⁷(C)ˆ CIRCLS⁴⁷ (14)

In addition, with respect to Equation (10), the use of product spaces for MAKO allows the use of fast computational algorithms similar to the Fast Fourier Transform algorithm for the Discrete Fourier Transform, which improves the computational efficiency by at least 2 orders of magnitude. In addition, it allows an increase of the block cipher size by several multiples of the cryptographic key size. For example, the partition size may be 8,192 bits as compared to a cryptographic key size of only 128 bits.

Further, with respect to Equation (11), the product symbol here, should be interpreted as the multiplication of all the factors Qⱼ(u), and is merely the primitive polynomial factorization of the equation for the roots of unity, u^{q-1}−1=0. The use of primitive polynomials in the cryptographic algorithm MAKO is a powerful technique for allowing efficient computation of logical arithmetic operations, and thus increases the overall speed of the algorithm by several factors.

The output from the S₂ box represents the final cipher product from MAKO. The encrypted SALT data is then appended to the encrypted partitioned image data to form the encrypted file for the clear text digital image.

The decryption version of the exemplary embodiment of MAKO follows the same functional block diagram as contained in FIG. 18. As is illustrated by that figure, the incoming encrypted data is processed by separating the encrypted image data from the encrypted SALT data and trajectory synchronization data. The encrypted SALT data is decrypted by passing it through the reversed S₂ box while using the trajectory T· and the cipher cryptographic key K₁. Then the trajectories are used by examining all technically feasible trajectories and matching their synchronization data with the previously decrypted data. Next the encrypted image data is subdivided into partitions for processing through the decrypted version of the cryptographic algorithm MAKO. As is illustrated by FIG. 18, the decryptor comprises running these encrypted partitions through a reversed MAKO. That is, they are passed successively through the reversed S₂ box, then the reversed S₁ box, and finally the reversed P box. The decrypted partitions are then put together to form a clear text version of the digital image data.

The MAKO TABLE in FIG. 32 comprises 256 hexadecimal entries which are used to modify nibbles in the incoming cipher subblocks in segment S₁ of MAKO. Each row of the MAKO TABLE can be considered as element of the permutation S(16) in the following manner. Each entry of the MAKO TABLE consists of two hexadecimal integers, (hg). If only the second hexadecimal number g is considered, then it can be regarded as a permutation of the column in which it appears. The constraint on the development of the MAKO TABLE is that no two rows, considered as elements of the permutation group S(16), can belong to the same normal subgroup of S(16). Otherwise, they are used to “tune” the cryptographic algorithm in terms of its cryptographic strength. It should also be recognized that other changes, substitutions and alterations are also possible without departing from the spirit and scope of the present invention, as defined by the following claims.

What is claimed is:

1. A method for authenticating a digital image comprising:
receiving a first digital image at an authentication center, the first digital image having an associated serial number and being encrypted;
storing the first digital image at the authentication center in response to the associated serial number;
receiving a second digital image at the authentication center, the second digital image being associated with the serial number;
decrypting the first digital image to generate a third digital image;
comparing the second digital image to the third digital image; and
reporting the result of the comparison.

2. The method for authenticating digital images according to claim 1 further comprising associating a camera key with each serial number and wherein decrypting the first digital image comprises decrypting the first digital image in response to the camera key associated with the serial number.

3. The method for authenticating digital images according to claim 2 further comprising:
generating the camera key at the authentication center;
generating the serial number at the authentication center; and
associating the camera key with the serial number.

4. The method for authenticating digital images according to claim 2 further comprising encrypting the camera key in response a first key at the authentication center.

5. The method for authenticating digital images according to claim 4 further comprising encrypting the first key in response to a second key at the authentication center.

6. The method for authenticating digital images according to claim 5 further comprising re-encrypting the first key at predetermined time intervals in response to a third key at the authentication center.

7. The method for authenticating digital images according to claim 1, wherein comparing the second digital image comprises comparing each bit of the second image to each bit of the third image.

8. The method for authenticating digital images according to claim 1 further comprising:
storing a plurality of distinct activator identifiers at the authentication center;
associating a unique activator key with each activator identifier; and
communicating a selected one of the activator identifiers and associated activator key to an activator.

9. The method for authenticating digital images according to claim 8, wherein communicating the selected one of the activator identifiers and associated activator key is performed securely.

10. The method for authenticating digital images according to claim 1 further comprising:
storing a plurality of distinct entity identifiers at the authentication center;
associating a unique entity key with each entity identifier; and
communicating a selected one of the entity identifiers and associated entity key to a verifying entity.

11. The method for authenticating digital images according to claim 10, wherein communicating the selected one of the activator identifiers and associated activator key is performed securely.

12. A system for authenticating a digital image comprising:
an authentication center operable to:
receive a first digital image, the first digital image having an associated serial number and being encrypted;
store the first digital image in response to the associated serial number;
receive a second digital image, the second digital image being associated with the serial number;
decrypt the first digital image to generate a third digital image;
compare the second digital image to the third digital image; and
report the result of the comparison.

13. The system for authenticating digital images according to claim 12, wherein the authentication center is further operable to associate a camera key with each serial number and wherein decrypting the first digital image comprises decrypting the first digital image in response to the camera key associated with the serial number.

14. The system for authenticating digital images according to claim 13, wherein the authentication center is further operable to:
generate the camera key;
generate the serial number; and
associate the camera key with the serial number.

15. The system for authenticating digital images according to claim 13, wherein the authentication center is further operable to encrypt the camera key in response a first key.

16. The system for authenticating digital images according to claim 15, wherein the authentication center is further operable to encrypt the first key in response to a second key.

17. The system for authenticating digital images according to claim 16, wherein the authentication center is further operable to re-encrypt the first key at predetermined time intervals in response to a third key.

18. The system for authenticating digital images according to claim 12, wherein the authentication center is further operable to compare each bit of the second image to each bit of the third image.

19. The system for authenticating digital images according to claim 12, wherein the authentication center is further operable to:
store a plurality of distinct activator identifiers;
associate a unique activator key with each activator identifier; and
communicate a selected one of the activator identifiers and associated activator key to an activator.

20. The system for authenticating digital images according to claim 19, wherein communicating the selected one of the activator identifiers and associated activator key is performed securely.

21. The system for authenticating digital images according to claim 12, wherein the authentication center is further operable to:
store a plurality of distinct entity identifiers;
associate a unique entity key with each entity identifier; and
communicate a selected one of the entity identifiers and associated entity key to a verifying entity.

22. The system for authenticating digital images according to claim 21, wherein communicating the selected one of the activator identifiers and associated activator key is performed securely.
